(19) United States
(12) Patent Application Publication
(10) Pub. No.: US 2026/0371347 A1
(43) Pub. Date: Nov. 19, 2026

(54) INDICATING A SWITCHING PERIOD LOCATION FOR UPLINK TRANSMIT SWITCHING

(71) Applicant: QUALCOMM Incorporated, San Diego, CA (US)

(72) Inventors: Yiqing CAO, Beijing (CN); Peter GAAL, San Diego, CA (US); Kazuki TAKEDA, Minato-ku (JP)

(21) Appl. No.: 19/126,474

(22) PCT Filed: Jan. 4, 2023
(86) PCT No.: PCT/CN2023/070310

§ 371 Date: May 1, 2025

(51) Int. Cl. H04W 72/21; H04L 5/00

(52) U.S. Cl. CPC H04W 72/21; H04L 5/0098

(57) ABSTRACT

Various aspects of the present disclosure generally relate to wireless communication. In some aspects, a user equipment (UE) may receive, for a first wireless communication carrier, a first uplink transmit switching configuration that indicates a first plurality of wireless communication carrier combinations, wherein the first wireless communication carrier is included in each of the first plurality of wireless communication carrier combinations. The UE may receive, for a second wireless communication carrier, a second uplink transmit switching configuration that indicates a second plurality of wireless communication carrier combinations, wherein the second wireless communication carrier is included in each of the second plurality of wireless communication carrier combinations. Numerous other aspects are described.

### FIELD OF THE DISCLOSURE

Aspects of the present disclosure generally relate to wireless communication and to techniques and apparatuses for indicating a switching period location for uplink transmit switching.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving, for a first wireless communication carrier, a first uplink transmit switching configuration that indicates a first plurality of wireless communication carrier combinations, where the first wireless communication carrier is included in each of the first plurality of wireless communication carrier combinations. The method may include receiving, for a second wireless communication carrier, a second uplink transmit switching configuration that indicates a second plurality of wireless communication carrier combinations, where the second wireless communication carrier is included in each of the second plurality of wireless communication carrier combinations.

Some aspects described herein relate to a method of wireless communication performed by a network node. The method may include transmitting, for a first wireless communication carrier, a first uplink transmit switching configuration that indicates a first plurality of wireless communication carrier combinations, where the first wireless communication carrier is included in each of the first plurality of wireless communication carrier combinations. The method may include transmitting, for a second wireless communication carrier, a second uplink transmit switching configuration that indicates a second plurality of wireless communication carrier combinations, where the second wireless communication carrier is included in each of the second plurality of wireless communication carrier combinations.

Some aspects described herein relate to a UE for wireless communication. The UE may include a memory and one or more processors coupled to the memory. The one or more processors may be configured to receive, for a first wireless communication carrier, a first uplink transmit switching configuration that indicates a first plurality of wireless communication carrier combinations, where the first wireless communication carrier is included in each of the first plurality of wireless communication carrier combinations. The one or more processors may be configured to receive, for a second wireless communication carrier, a second uplink transmit switching configuration that indicates a second plurality of wireless communication carrier combinations, where the second wireless communication carrier is included in each of the second plurality of wireless communication carrier combinations.

Some aspects described herein relate to a network node for wireless communication. The network node may include a memory and one or more processors coupled to the memory. The one or more processors may be configured to transmit, for a first wireless communication carrier, a first uplink transmit switching configuration that indicates a first plurality of wireless communication carrier combinations, where the first wireless communication carrier is included in each of the first plurality of wireless communication carrier combinations. The one or more processors may be configured to transmit, for a second wireless communication carrier, a second uplink transmit switching configuration that indicates a second plurality of wireless communication carrier combinations, where the second wireless communication carrier is included in each of the second plurality of wireless communication carrier combinations.

Some aspects described herein relate to a non-transitory computer-readable medium that stores a set of instructions for wireless communication by a UE. The set of instructions, when executed by one or more processors of the UE, may cause the UE to receive, for a first wireless communication carrier, a first uplink transmit switching configuration that indicates a first plurality of wireless communication carrier combinations, where the first wireless communication carrier is included in each of the first plurality of wireless communication carrier combinations. The set of instructions, when executed by one or more processors of the UE, may cause the UE to receive, for a second wireless communication carrier, a second uplink transmit switching configuration that indicates a second plurality of wireless communication carrier combinations, where the second wireless communication carrier is included in each of the second plurality of wireless communication carrier combinations.

Some aspects described herein relate to a non-transitory computer-readable medium that stores a set of instructions for wireless communication by a network node. The set of instructions, when executed by one or more processors of the network node, may cause the network node to transmit, for a first wireless communication carrier, a first uplink transmit switching configuration that indicates a first plurality of wireless communication carrier combinations, where the first wireless communication carrier is included in each of the first plurality of wireless communication carrier combinations. The set of instructions, when executed by one or more processors of the network node, may cause the network node to transmit, for a second wireless communication carrier, a second uplink transmit switching configuration that indicates a second plurality of wireless communication carrier combinations, where the second wireless communication carrier is included in each of the second plurality of wireless communication carrier combinations.

Some aspects described herein relate to an apparatus for wireless communication. The apparatus may include means for receiving, for a first wireless communication carrier, a first uplink transmit switching configuration that indicates a first plurality of wireless communication carrier combinations, where the first wireless communication carrier is included in each of the first plurality of wireless communication carrier combinations. The apparatus may include means for receiving, for a second wireless communication carrier, a second uplink transmit switching configuration that indicates a second plurality of wireless communication carrier combinations, where the second wireless communication carrier is included in each of the second plurality of wireless communication carrier combinations.

Some aspects described herein relate to an apparatus for wireless communication. The apparatus may include means for transmitting, for a first wireless communication carrier, a first uplink transmit switching configuration that indicates a first plurality of wireless communication carrier combinations, where the first wireless communication carrier is included in each of the first plurality of wireless communication carrier combinations. The apparatus may include means for transmitting, for a second wireless communication carrier, a second uplink transmit switching configuration that indicates a second plurality of wireless communication carrier combinations, where the second wireless communication carrier is included in each of the second plurality of wireless communication carrier combinations.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a transmit (Tx) chain and a receive (Rx) chain of a UE, in accordance with the present disclosure.

FIGS. 5A and 5B are diagrams of examples of uplink transmit switching, in accordance with the present disclosure.

FIG. 6 is a diagram of an example of indicating a switching period location for uplink transmit switching, in accordance with the present disclosure.

FIGS. 7A and 7B are diagrams of examples of uplink transmit switching configurations, in accordance with the present disclosure.

FIGS. 8A and 8B are diagrams of examples of uplink transmit switching configurations, in accordance with the present disclosure.

FIGS. 9A and 9B are diagrams of an example of downlink signaling for transmitting uplink transmit switching configurations, in accordance with the present disclosure.

FIG. 10 is a diagram illustrating an example process performed, for example, by a UE, in accordance with the present disclosure.

FIG. 11 is a diagram illustrating an example process performed, for example, by a network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

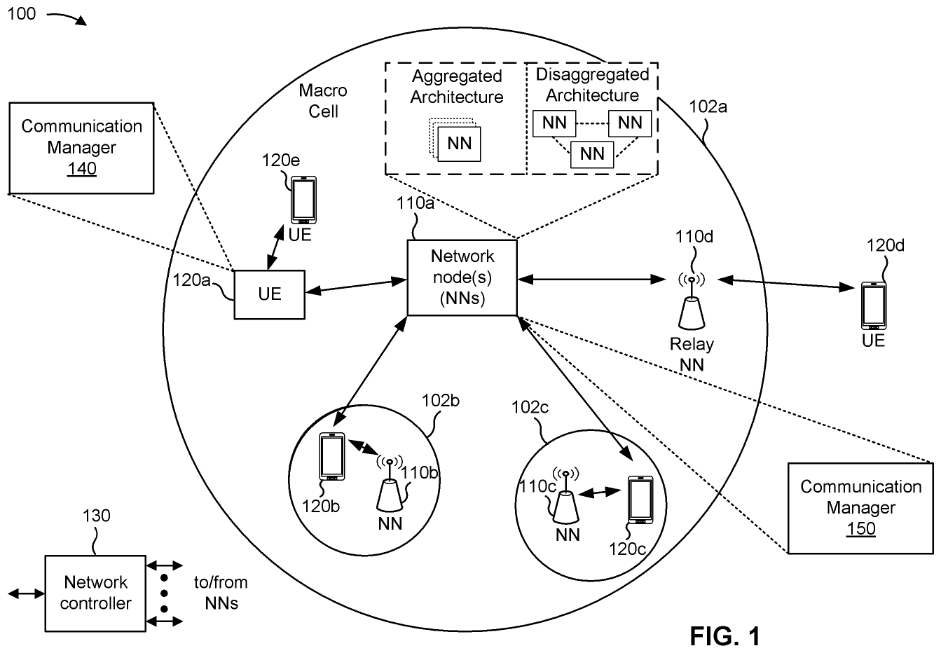

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE 120 may include a communication manager 140. As described in more detail elsewhere herein, the communication manager 140 may receive, for a first wireless communication carrier, a first uplink transmit switching configuration that indicates a first plurality of wireless communication carrier combinations, wherein the first wireless communication carrier is included in each of the first plurality of wireless communication carrier combinations; and receive, for a second wireless communication carrier, a second uplink transmit switching configuration that indicates a second plurality of wireless communication carrier combinations, wherein the second wireless communication carrier is included in each of the second plurality of wireless communication carrier combinations. Additionally, or alternatively, the communication manager 140 may perform one or more other operations described herein.

In some aspects, a network node 110 may include a communication manager 150. As described in more detail elsewhere herein, the communication manager 150 may transmit, for a first wireless communication carrier, a first uplink transmit switching configuration that indicates a first plurality of wireless communication carrier combinations, wherein the first wireless communication carrier is included in each of the first plurality of wireless communication carrier combinations; and transmit, for a second wireless communication carrier, a second uplink transmit switching configuration that indicates a second plurality of wireless communication carrier combinations, wherein the second wireless communication carrier is included in each of the second plurality of wireless communication carrier combinations. Additionally, or alternatively, the communication manager 150 may perform one or more other operations described herein.

As indicated above, FIG. 1 is provided as an example. Other examples may differ from what is described with regard to FIG. 1.

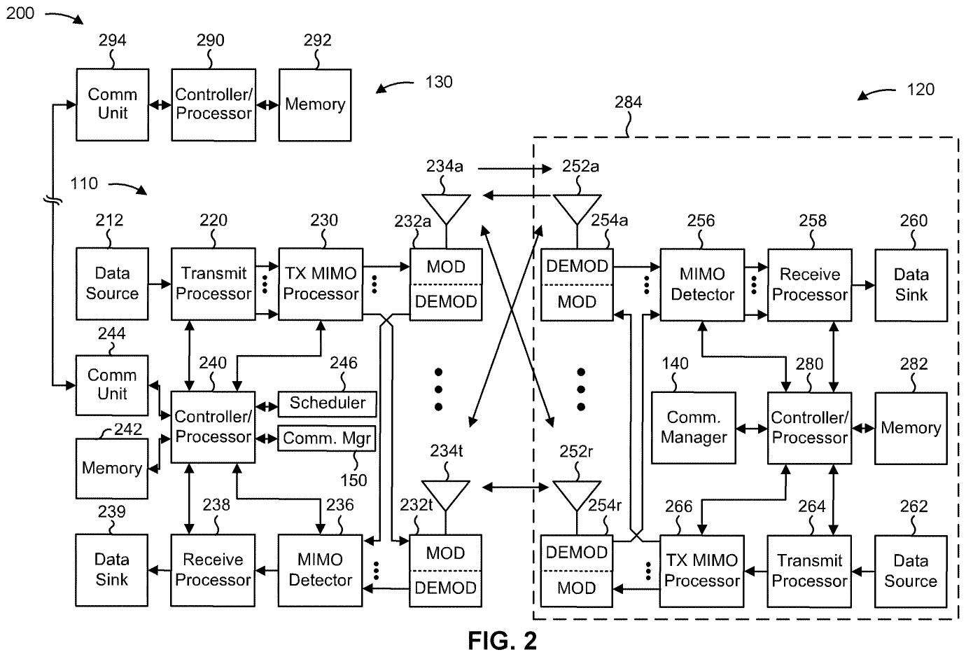

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

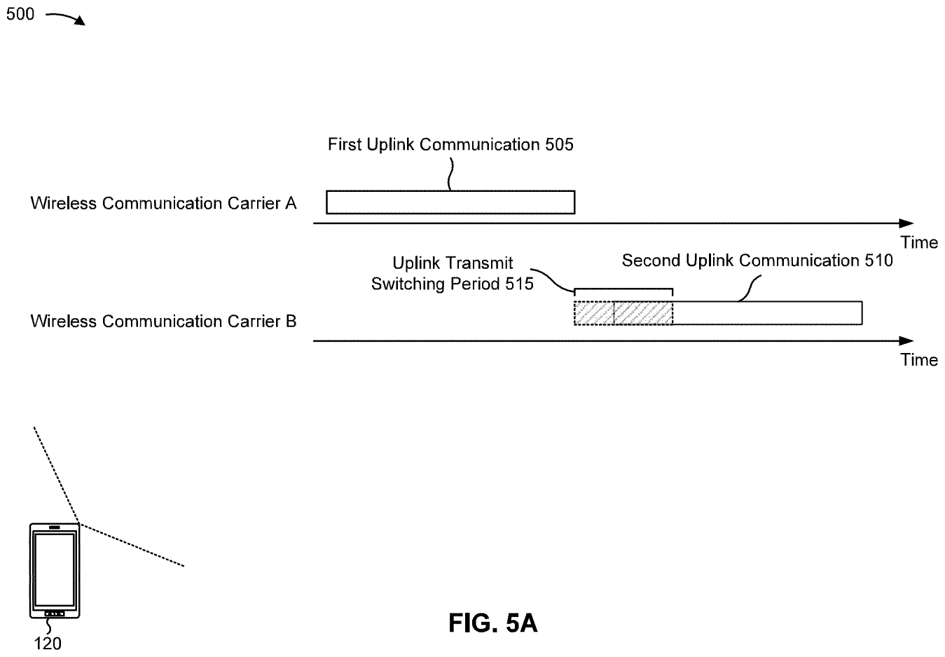

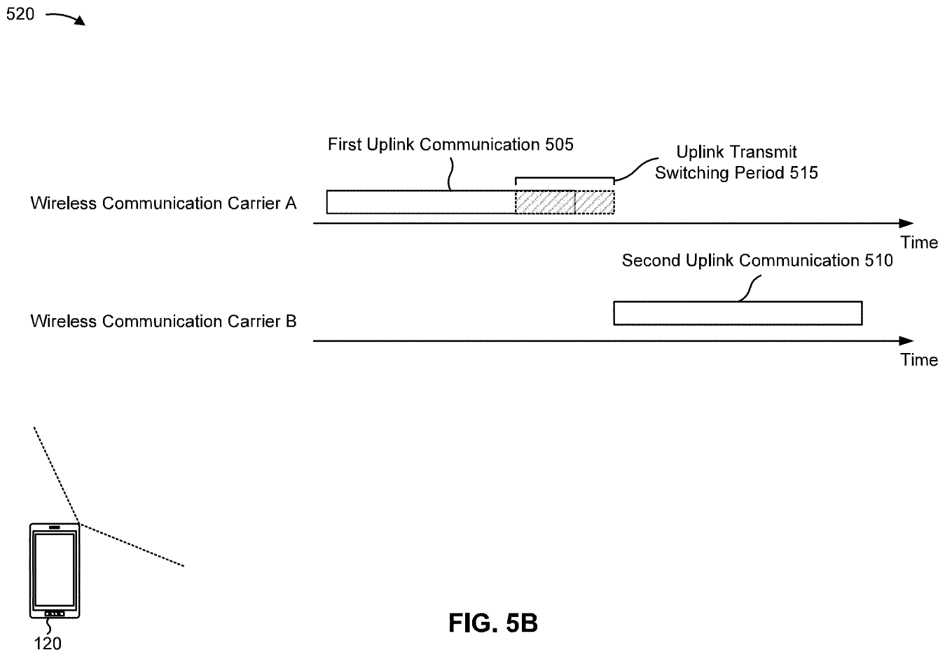

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5A-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5A-13).

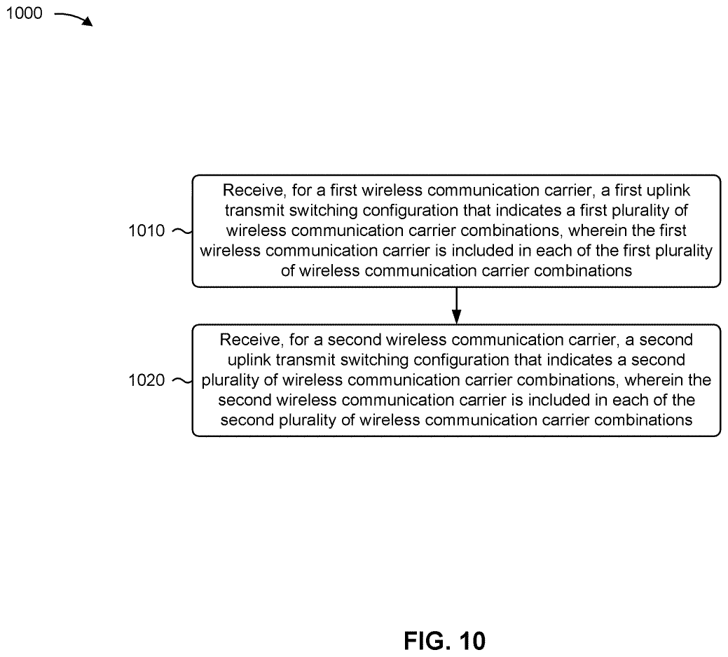

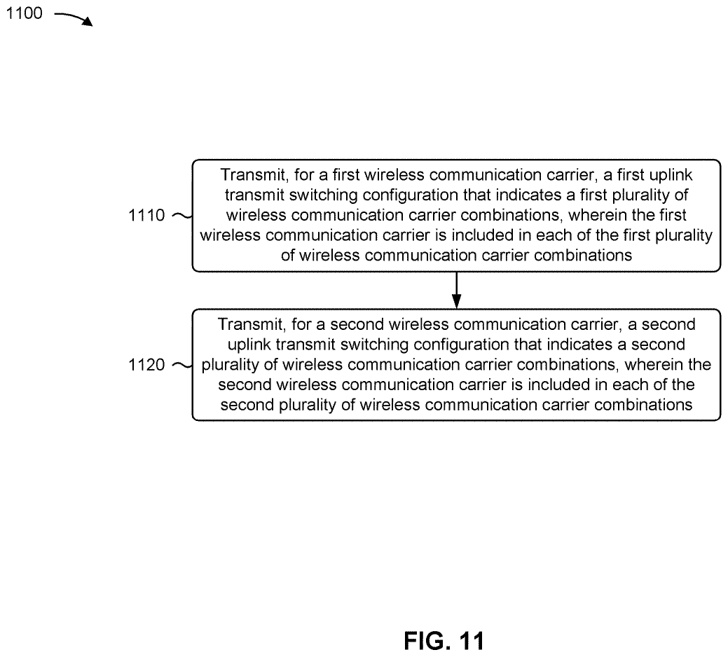

The controller/processor 240 of the network node 110, the controller/processor 280 of the UE 120, and/or any other component(s) of FIG. 2 may perform one or more techniques associated with indicating a switching period location for uplink transmit switching, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, the UE 120 includes means for receiving, for a first wireless communication carrier, a first uplink transmit switching configuration that indicates a first plurality of wireless communication carrier combinations, wherein the first wireless communication carrier is included in each of the first plurality of wireless communication carrier combinations; and/or means for receiving, for a second wireless communication carrier, a second uplink transmit switching configuration that indicates a second plurality of wireless communication carrier combinations, wherein the second wireless communication carrier is included in each of the second plurality of wireless communication carrier combinations. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, for a first wireless communication carrier, a first uplink transmit switching configuration that indicates a first plurality of wireless communication carrier combinations, wherein the first wireless communication carrier is included in each of the first plurality of wireless communication carrier combinations; and/or means for transmitting, for a second wireless communication carrier, a second uplink transmit switching configuration that indicates a second plurality of wireless communication carrier combinations, wherein the second wireless communication carrier is included in each of the second plurality of wireless communication carrier combinations. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

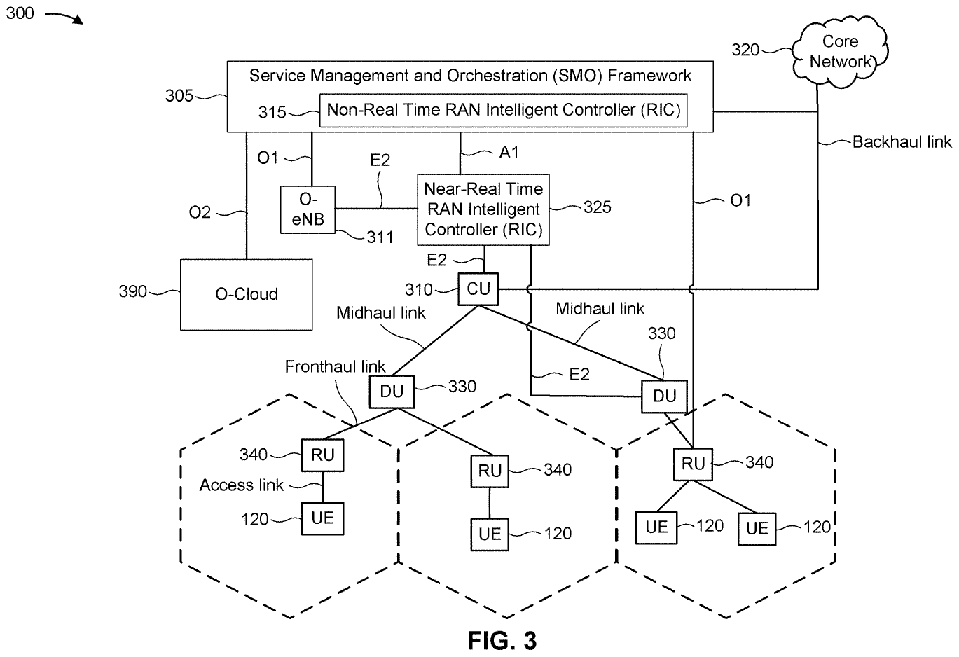

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

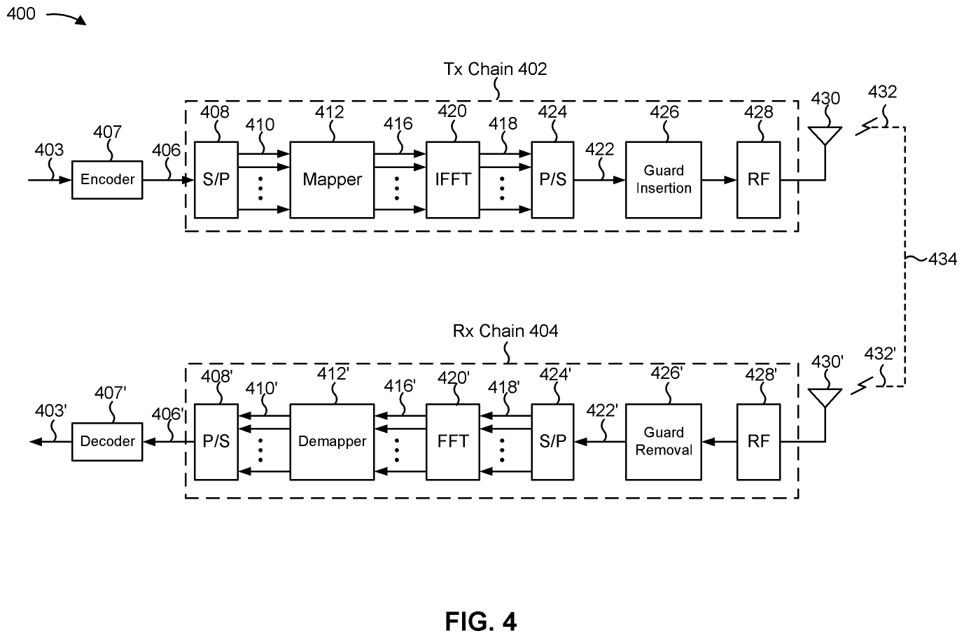

FIG. 4 is a diagram illustrating an example 400 of a transmit (Tx) chain 402 and a receive (Rx) chain 404 of a UE 120, in accordance with the present disclosure. In some aspects, one or more components of Tx chain 402 may be implemented in transmit processor 264, TX MIMO processor 266, modem 254, and/or controller/processor 280, as described above in connection with FIG. 2. In some aspects, Tx chain 402 may be implemented in UE 120 for transmitting data 406 (e.g., uplink data, an uplink reference signal, and/or uplink control information) to a network node 110 on an uplink channel.

An encoder 407 may alter a signal (e.g., a bitstream) 403 into data 406. Data 406 to be transmitted is provided from encoder 407 as input to a serial-to-parallel (S/P) converter 408. In some aspects, S/P converter 408 may split the transmission data into N parallel data streams 410.

The N parallel data streams 410 may then be provided as input to a mapper 412. Mapper 412 may map the N parallel data streams 410 onto N constellation points. The mapping may be done using a modulation constellation, such as binary phase-shift keying (BPSK), quadrature phase-shift keying (QPSK), 8 phase-shift keying (8PSK), quadrature amplitude modulation (QAM), etc. Thus, mapper 412 may output N parallel symbol streams 416, each symbol stream 416 corresponding to one of N orthogonal subcarriers of an inverse fast Fourier transform (IFFT) component 420. These N parallel symbol streams 416 are represented in the frequency domain and may be converted into N parallel time domain sample streams 418 by IFFT component 420.

In some aspects, N parallel modulations in the frequency domain correspond to N modulation symbols in the frequency domain, which are equal to N mapping and N-point IFFT in the frequency domain, which are equal to one (useful) OFDM symbol in the time domain, which are equal to N samples in the time domain. One OFDM symbol in the time domain, Ns, is equal to Ncp (the number of guard samples per OFDM symbol)+N (the number of useful samples per OFDM symbol).

The N parallel time domain sample streams 418 may be converted into an OFDM/OFDMA symbol stream 422 by a parallel-to-serial (P/S) converter 424. A guard insertion component 426 may insert a guard interval between successive OFDM/OFDMA symbols in the OFDM/OFDMA symbol stream 422. The output of guard insertion component 426 may then be upconverted to a desired transmit frequency band by an RF front end 428. An antenna 430 may then transmit the resulting signal 432.

In some aspects, Rx chain 404 may utilize OFDM/OFDMA. In some aspects, one or more components of Rx chain 404 may be implemented in receive processor 258, MIMO detector 256, modem 254, and/or controller/processor 280, as described above in connection with FIG. 2. In some aspects, Rx chain 404 may be implemented in UE 120 for receiving data 406 (e.g., downlink data, a downlink reference signal, and/or downlink control information) from a network node 110 on a downlink channel.

A transmitted signal 432 is shown traveling over a wireless channel 434 from Tx chain 402 to Rx chain 404. When a signal 432′ is received by an antenna 430′, the received signal 432′ may be downconverted to a baseband signal by an RF front end 428′. A guard removal component 426′ may then remove the guard interval that was inserted between OFDM/OFDMA symbols by guard insertion component 426.

The output of guard removal component 426′ may be provided to an S/P converter 424′. The output may include an OFDM/OFDMA symbol stream 422′, and S/P converter 424′ may divide the OFDM/OFDMA symbol stream 422′ into N parallel time-domain symbol streams 418′, each of which corresponds to one of the N orthogonal subcarriers. An FFT component 420′ may convert the N parallel time-domain symbol streams 418′ into the frequency domain and output N parallel frequency-domain symbol streams 416′.

A demapper 412′ may perform the inverse of the symbol mapping operation that was performed by mapper 412, thereby outputting N parallel data streams 410′. A P/S converter 408′ may combine the N parallel data streams 410′ into a single data stream 406′. Ideally, data stream 406′ corresponds to data 406 that was provided as input to Tx chain 402. Data stream 406′ may be decoded into a decoded data stream 403′ by decoder 407′.

In some aspects, a UE 120 may include a plurality of Tx chains 402 and/or a plurality of Rx chains 404. This enables the UE 120 to be configured to communicate on a plurality of wireless communication carriers or bands.

The number and arrangement of components shown in FIG. 4 are provided as an example. In practice, there may be additional components, fewer components, different components, or differently arranged components than those shown in FIG. 4. Furthermore, two or more components shown in FIG. 4 may be implemented within a single component, or a single component shown in FIG. 4 may be implemented as multiple, distributed components. Additionally, or alternatively, a set of components (e.g., one or more components) shown in FIG. 4 may perform one or more functions described as being performed by another set of components shown in FIG. 4.

FIGS. 5A and 5B are diagrams of examples of uplink transmit switching, in accordance with the present disclosure. As shown in FIGS. 5A and 5B, the examples 500 of uplink transmit switching may be performed by a UE 120. The UE 120 may be included in a wireless network, such as the wireless network 100.

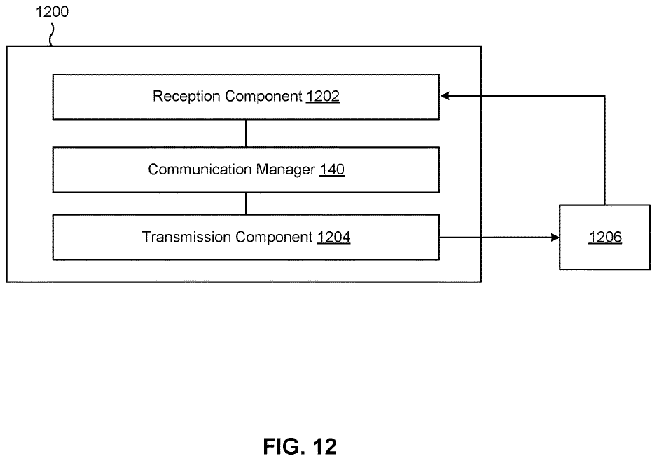

As shown in an example 500 in FIG. 5A, the UE 120 may transmit (e.g., using the communication manager 140, the transmit processor 264, the controller/processor 280, one or more Tx chains 402, a transmission component 1204 described in connection with FIG. 12) a first uplink communication 505 on a wireless communication carrier A configured for the UE 120. The UE 120 may transmit (e.g., using the communication manager 140, the transmit processor 264, the controller/processor 280, one or more Tx chains 402, a transmission component 1204 described in connection with FIG. 12) a second uplink communication 510 on a wireless communication carrier B configured for the UE 120. The UE 120 may transmit the second uplink communication 510 after the first uplink communication 505. A wireless communication carrier may refer to a band (e.g., a wireless communication band), a sub-band, a subcarrier, and/or a plurality of contiguous subcarriers, among other examples.

The UE 120 may perform (e.g., using the communication manager 140, the transmit processor 264, the controller/processor 280, one or more Tx chains 402, a transmission component 1204 described in connection with FIG. 12) a carrier switch in which the UE 120 switches one or more Tx chains 402 of the UE 120 from the wireless communication carrier A to the wireless communication carrier B. This carrier switch may be performed during an uplink transmit switching period 515. The uplink transmit switching period 515 refers to the time duration for the UE 120 to switch the one or more Tx chains 402 between wireless communication carriers. In the example 500, the uplink transmit switching period 515 refers to the time duration for the UE 120 to switch the one or more Tx chains 402 from the wireless communication carrier A to the wireless communication carrier B.

The UE 120 may determine (e.g., using the communication manager 140, the transmit processor 264, the controller/processor 280) an uplink transmit switching period location for the uplink transmit switching period 515. The uplink transmit switching period location refers to the wireless communication carrier on which the UE 120 is to perform the carrier switch in the uplink transmit switching period 515. As shown in the example 500 in FIG. 5A, the UE 120 may determine the uplink transmit switching period location to be on the wireless communication carrier B. Here, the uplink transmit switching period 515 occurs on the wireless communication carrier B.

As shown in FIG. 5A, performing the carrier switch in the uplink transmit switching period 515 on the wireless communication carrier B refers to the carrier switch being performed according to the timeline of the wireless communication carrier B. In other words, performing the carrier switch in the uplink transmit switching period 515 on the wireless communication carrier B means that the UE 120 selects the wireless communication carrier B to be impacted by the time duration for switching the one or more Tx chains 402 of the UE 120 from the wireless communication carrier A to the wireless communication carrier B. Thus, if the duration of the uplink transmit switching period 515 exceeds the time between the end of the first uplink communication 505 and a start of the second uplink communication 510, the uplink transmit switching period location being on the wireless communication carrier B results in the UE 120 dropping or refraining from transmitting at least a portion of the second uplink communication 510 so that the UE 120 can instead complete the carrier switch after starting the uplink transmit switching period 515 after completing the transmission of the first uplink communication 505. The UE 120 transmits the remaining portion of the second uplink communication 510 on the wireless communication carrier B after completing the carrier switch.

As shown in an example 520 in FIG. 5A, the UE 120 may determine the uplink transmit switching period location to be on the wireless communication carrier A. Here, the uplink transmit switching period 515 occurs on the wireless communication carrier A. Performing the carrier switch in the uplink transmit switching period 515 on the wireless communication carrier A refers to the carrier switch being performed according to the timeline of the wireless communication carrier A. In other words, performing the carrier switch in the uplink transmit switching period 515 on the wireless communication carrier A means that the UE 120 selects the wireless communication carrier A to be impacted by the time duration for switching the one or more Tx chains 402 of the UE 120 from the wireless communication carrier A to the wireless communication carrier B. Thus, if the duration of the uplink transmit switching period 515 exceeds the time between the end of the first uplink communication 505 and a start of the second uplink communication 510, the uplink transmit switching period location being on the wireless communication carrier A results in the UE 120 dropping or refraining from transmitting at least a portion of the first uplink communication 505 during the uplink transmit switching period 515 so that the UE 120 can instead complete the carrier switch by the start of the second uplink communication 510.

As indicated above, FIGS. 5A and 5B are provided as examples. Other examples may differ from what is described with regard to FIGS. 5A and 5B.

As described above, a UE may be scheduled or configured to perform carrier switching between two or more wireless communication carriers for uplink transmit switching. A UE that is to switch the Tx chains of the UE between wireless communication carriers for transmitting uplink communications on different wireless communication carriers needs time to execute the carrier switch. For example, the UE transmits a first uplink communication on a first wireless communication carrier, and then switches the Tx chains of the UE to a second wireless communication carrier to transmit a second uplink communication on the second wireless communication band. The time it takes the UE to switch the Tx chains of the UE from the first wireless communication carrier to the second wireless communication carrier is referred to as an uplink transmit switching duration. In some cases, the uplink transmit switching duration can at least partially overlap in time with one or more of the first uplink communication or the second uplink communication. Thus, the location of the uplink transmit switching period (referred to as the uplink transmit switching period location) may cause at least a portion of one or more of the first uplink communication or the second uplink communication to be dropped.

In some cases, a network node may signal, to the UE, the uplink transmit switching period location for a wireless communication carrier combination. Signaling mechanisms in a wireless network may enable support for uplink transmit switching for 2 wireless communication carriers. However, as the quantity of supported wireless communication carriers for uplink transmit switching increases, so too does the signaling overhead for the network node to signal uplink switching period locations for each wireless communication carrier combination on each of the wireless communication carriers. Increasing the quantity of supported wireless communication carriers for uplink transmit switching may result in a significant increase in wireless communication carrier combinations and a corresponding significant signaling overhead increase for signaling the uplink transmit switching period location for all of the wireless communication carrier combinations on all of the wireless communication carriers scheduled or configured for the UE.

In some aspects described herein, a UE may be provided with uplink transmit switching configurations for only a subset of wireless communication carriers scheduled or configured for the UE. As an example, if the UE is scheduled or configured for uplink transmit switching on 4 wireless communication carriers, the UE may be provided with uplink transmit switching configurations for 3 of the 4 wireless communication carriers. A network node may configure the uplink transmit switching configurations to indicate uplink transmit switching period locations for wireless communication carrier combinations of the wireless communication carriers. In particular, the network node may conserve signaling overhead by including, in an uplink transmit switching configuration for a wireless communication carrier, only the wireless communication carrier combinations that include the wireless communication carrier combinations.

Wireless communication carrier combinations that do not include the wireless communication carrier may not be relevant or used for the wireless communication carrier, and therefore would otherwise increase signaling overhead in the wireless network without an added benefit. Accordingly, the network node may omit wireless communication carrier combinations that do not include the wireless communication carrier from the uplink transmit switching configuration for the wireless communication carrier to reduce signaling overhead (e.g., to reduce the consumption of network resources in the wireless network, to reduce the consumption of processing and memory resources of the network node). The network node may configure each uplink transmit switching configurations for each of the subset of wireless communication carriers in a similar manner to further reduce signaling overhead.

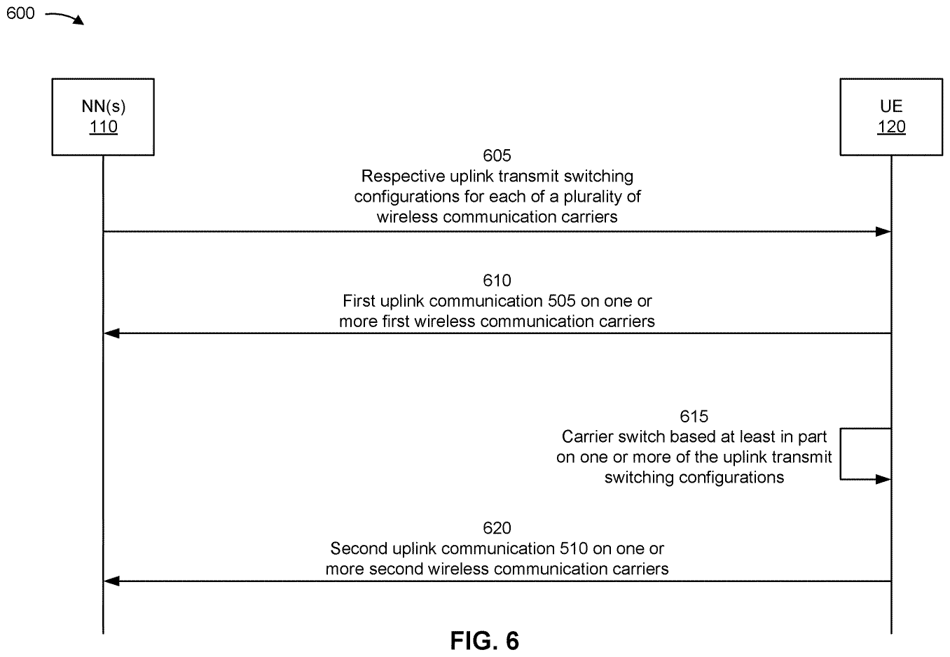

FIG. 6 is a diagram of an example 600 of indicating a switching period location for uplink transmit switching, in accordance with the present disclosure. As shown in FIG. 6, the example 600 may include communication between one or more network nodes 110 and a UE 120. In some aspects, the network node(s) 110 and the UE 120 may be included in a wireless network, such as the wireless network 100. In some aspects, the network node(s) 110 may be configured as a disaggregated base station architecture 300 in which the UE 120 communicates with RUs 340 of network node(s) 110.

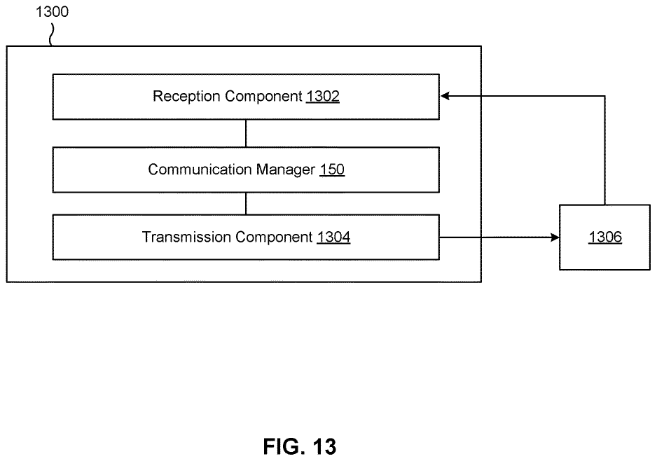

At 605, to indicate a switching period location for uplink transmit switching, a network node 110 may transmit (and the UE 120 may receive) respective uplink transmit switching configurations for each of a plurality of wireless communication carriers associated with the UE 120. The network node 110 may transmit the respective uplink transmit switching configurations using the communication manager 150, the transmit processor 220, the controller/processor 240, one or more Tx chains 402, and/or a transmission component 1304 described in connection with FIG. 13, among other examples. The UE 120 may receive the respective uplink transmit switching configurations using the communication manager 140, the receive processor 258, the controller/processor 280, one or more Rx chains 404, and/or a reception component 1202 described in connection with FIG. 12, among other examples.

In some aspects, the network node 110 may transmit (and the UE 120 may receive) respective uplink transmit switching configurations for each of a plurality of wireless communication carriers in one or more RRC communications, in one or more MAC control element (MAC-CE) communications, in one or more downlink control information (DCI) communications, and/or in one or more downlink communications of another type.

Additionally and/or alternatively, a first network node 110 may transmit (and the UE 120 may receive) a first subset of uplink transmit switching configurations for a first subset of the plurality of wireless communication carriers, a second network node 110 may transmit (and the UE 120 may receive) a second subset of uplink transmit switching configurations for a second subset of the plurality of wireless communication carriers, and so on.

Additionally and/or alternatively, a network node 110 may transmit (and the UE 120 may receive) a first subset of uplink transmit switching configurations for a first subset of the plurality of wireless communication carriers on a first wireless communication carrier (or band), a network node 110 may transmit (and the UE 120 may receive) a second subset of uplink transmit switching configurations for a second subset of the plurality of wireless communication carriers on a second wireless communication carrier (or band), and so on.

In some aspects, the uplink transmit switching configuration for a particular wireless communication carrier may be transmitted and received on the wireless communication carrier.

In some aspects, L wireless communication carriers (or bands) may be configured for the UE 120, and the network node 110 may transmit (and the UE 120 may receive) respective uplink transmit switching configurations for a subset of the L wireless communication carriers. In some aspects, the network node 110 may transmit (and the UE 120 may receive) respective uplink transmit switching configurations for each of a quantity of L-1 of the L wireless communication carriers. For example, if the UE 120 is configured with 3 wireless communication carriers, the network node 110 may transmit (and the UE 120 may receive) respective uplink transmit switching configurations for each of 2 wireless communication carriers of the 3 wireless communication carriers configured for the UE 120. As another example, if the UE 120 is configured with 4 wireless communication carriers, the network node 110 may transmit (and the UE 120 may receive) respective uplink transmit switching configurations for each of 3 wireless communication carriers of the 3 wireless communication carriers configured for the UE 120.

An uplink transmit switching configuration may include a plurality of wireless communication carrier combinations and an indication of a respective uplink transmit switching period location for each of the plurality of wireless communication carrier combinations. Thus, a first uplink transmit switching configuration for a first wireless communication carrier may include a first plurality of wireless communication carrier combinations and an indication of a respective uplink transmit switching period location for each of the first plurality of wireless communication carrier combinations; a second uplink transmit switching configuration for a second wireless communication carrier may include a second plurality of wireless communication carrier combinations and an indication of a respective uplink transmit switching period location for each of the second plurality of wireless communication carrier combinations, and so on.

The plurality of wireless communication carrier combinations in an uplink transmit switching configuration for a particular wireless communication carrier (or band) may each include the wireless communication carrier. In other words, wireless communication carrier combinations that do not include the wireless communication carrier are omitted from the uplink transmit switching configuration for the wireless communication carrier. Wireless communication carrier combinations that do not include the wireless communication carrier may not be relevant or used for the wireless communication carrier, and therefore increase signaling overhead in the wireless network without an added benefit. Accordingly, the network node 110 may omit wireless communication carrier combinations that do not include the wireless communication carrier from the uplink transmit switching configuration for the wireless communication carrier to reduce signaling overhead (e.g., to reduce the consumption of network resources in the wireless network, to reduce the consumption of processing and memory resources of the network node 110). The network node 110 may configure each transmitted uplink transmit switching configuration in a similar manner by omitting, for each wireless communication carrier for which an uplink transmit switching configuration is provided, wireless communication carrier combinations that do not include the wireless communication carrier.

An indication of an uplink transmit switching period location for a wireless communication carrier combination indicates the subset of wireless communication carrier(s) in the wireless communication carrier combination on which the UE 120 is to perform an uplink transmit switch between different subsets of wireless communication carriers in the wireless communication carrier combination. For example, if a wireless communication carrier combination includes a wireless communication carrier A and a wireless communication carrier B, an indication of an uplink transmit switching period location may indicate that the location of the time period of performing an uplink transmit switch between the wireless communication carrier A and the wireless communication carrier B is to occur on the wireless communication carrier A. Alternatively, the indication of an uplink transmit switching period location may indicate that the location of the time period of performing an uplink transmit switch between the wireless communication carrier A and the wireless communication carrier B is to occur on the wireless communication carrier B.

In some aspects, a wireless communication carrier combination may be included in uplink transmit switching configurations for more than one wireless communication band. For example, a wireless communication carrier combination that includes a wireless communication carrier A and a wireless communication carrier B may be included in a first uplink transmit switching configuration for the wireless communication carrier A, as well as in a second uplink transmit switching configuration for the wireless communication carrier B. In some cases, the first uplink transmit switching configuration and the second uplink transmit switching configuration may indicate different uplink transmit switching period locations for this wireless communication carrier combination. For example, the first uplink transmit switching configuration may configure the uplink transmit switching period location to be on the wireless communication carrier B for the wireless communication carrier combination, and the second uplink transmit switching configuration may configure the uplink transmit switching period location to be on the wireless communication carrier A for the wireless communication carrier combination. This is referred to herein as a conflict. The network node 110 may indicate to the UE 120 one or more priority parameters for resolving such conflicts. The one or more priority parameters may be explicitly and/or implicitly indicated in one or more uplink transmit switching configurations, in one or more RRC communications, in one or more MAC-CE communications, in one or more DCI communications, and/or in one or more downlink communications of another type.

In some aspects, the network node 110 transmits (and the UE 120 receives) an explicit indication of a wireless communication carrier priority for resolving a conflicts. For example, the network node 110 may transmit (and the UE 120 may receive) an explicit indication that a wireless communication carrier A is the priority carrier for uplink transmit switching. Accordingly, the UE 120 may determine the uplink transmit switching period location to be the wireless communication carrier A for any wireless communication carrier combination that includes the wireless communication carrier A.

The network node 110 may explicitly indicate a priority for each wireless communication carrier configured for the UE 120. For example, the network node 110 may transmit (and the UE 120 may receive) a priority order in which a wireless communication carrier A is first priority for uplink transmit switching, a wireless communication carrier B is second priority for uplink transmit switching, and a wireless communication carrier C is third priority for uplink transmit switching. The priority order may be indicated in ascending order, in descending order, or in another order.

As another example, the network node 110 may transmit (and the UE 120 may receive) per-combination priorities. In other words, the network node 110 may indicate a respective wireless communication carrier priority for each different wireless communication carrier combination indicated to the UE 120. For example, the network node 110 may indicate that a wireless communication carrier A takes priority in a wireless communication carrier combination that includes the wireless communication carrier A and a wireless communication B, the network node 110 may indicate that a wireless communication carrier C takes priority in a wireless communication carrier combination that includes the wireless communication carrier A and the wireless communication C, the network node 110 may indicate that a wireless communication carrier B takes priority in a wireless communication carrier combination that includes the wireless communication carrier B and the wireless communication C, and so on.

As indicated above, wireless communication carrier priority for resolving a conflicts can be indicated per wireless communication carrier (e.g., a wireless communication carrier A takes priority in wireless communication carrier combinations including the wireless communication carrier A). Alternatively, the network node 110 may transmit (and the UE 120 may receive) an indication that the uplink transmit switching period locations indicated in an uplink transmit switching configuration for a particular wireless communication carrier takes priority for resolving conflicts. In these aspects, if the network node 110 indicates that the uplink transmit switching period locations indicated in an uplink transmit switching configuration for a wireless communication carrier A takes priority, all wireless communication carrier combinations that a wireless communication carrier B have in common with the wireless communication carrier A adopt the relevant uplink transmit switching period locations indicated in the uplink transmit switching configuration for the wireless communication carrier A.

In some aspects, the network node 110 implicitly indicates the priority for resolving conflicts based at least in part on how the uplink transmit switching configurations are configured for the wireless communication carriers for the UE 120. For example, the network node 110 may transmit (and the UE 120 may receive) a first uplink transmit switching configuration for a wireless communication A that includes a one or more first of wireless communication carrier combinations and associated uplink transmit switching period location indications. The network node 110 may transmit (and the UE 120 may receive) a second uplink transmit switching configuration for a wireless communication B that includes one or more second wireless communication carrier combinations and associated uplink transmit switching period location indications, where the one or more second wireless communication carrier combinations are not included in the first uplink transmit switching combination. The network node 110 may transmit (and the UE 120 may receive) a third uplink transmit switching configuration for a wireless communication C that includes one or more third wireless communication carrier combinations and associated uplink transmit switching period location indications, where the one or more third wireless communication carrier combinations are not included in the first uplink transmit switching combination and are not included in the second uplink transmit switching combination. Similar configurations for different quantities of wireless communication carriers are within the scope of the present disclosure.

Thus, the one or more first wireless communication carrier combinations are exclusive to the first uplink transmit switching configuration and do not conflict with the wireless communication carrier combinations included in the second and third uplink transmit switching configurations. The one or more second wireless communication carrier combinations are exclusive to the second uplink transmit switching configuration and do not conflict with the wireless communication carrier combinations included in the first and third uplink transmit switching configurations. The one or more third wireless communication carrier combinations are exclusive to the third uplink transmit switching configuration and do not conflict with the wireless communication carrier combinations included in the first and second uplink transmit switching configurations. In this way, the way that the network node 110 configured the uplink transmit switching configurations implicitly indicates priority and resolves any potential conflicts.

In some aspects, the network node 110 transmits (and the UE 120 receives) an indication that the wireless communication carrier, in a wireless communication carrier combination, with the longest switching period duration takes priority for the uplink transmit switching period location for the wireless communication carrier combination. For example, if a wireless communication carrier combination includes a wireless communication carrier B and a wireless communication carrier D, the UE 120 may determine the uplink transmit switching period location to be the wireless communication carrier B based at least in part on the switching period duration on the wireless communication carrier B being greater relative to the switching period duration on the wireless communication carrier D (e.g., if T_{switch,B}>T_{switch,D}). As another example, for carrier switching from a wireless communication carrier A +a wireless communication carrier B to a wireless communication carrier C, the UE 120 may determine the uplink transmit switching period location to be the wireless communication carrier A based at least in part on the switching period duration from the wireless communication carrier A to the wireless communication carrier C being greater relative to the switching period duration from the wireless communication carrier B to the wireless communication carrier C (e.g., if T_{switch,A_C}>T_{switch,B_C}).

In some aspects, the network node 110 indicates to the UE 120 that selection of the uplink transmit switching period location is left up to the UE 120 (e.g., based at least in part on a UE implementation of the UE 120) for resolving conflicts. Alternatively, the network node 110 may indicate to the UE 120 that the UE 120 may randomly (or pseudo-randomly) select of the uplink transmit switching period location for resolving conflicts.

At 610, the UE 120 may transmit (and a network node 110 may receive) a first uplink communication 505 on one or more first wireless communication carriers configured for the UE 120. The UE 120 may transmit the first uplink communication 505 using the communication manager 140, the transmit processor 264, the controller/processor 280, one or more Tx chains 402, and/or a transmission component 1204 described in connection with FIG. 12, among other examples. The network node 110 may receive the first uplink communication 505 using the communication manager 150, the receive processor 238, the controller/processor 240, one or more Rx chains 404, and/or a reception component 1302 described in connection with FIG. 13, among other examples.

The UE 120 may be scheduled or configured to transmit a second uplink communication 510 after transmission of the first uplink communication 505. The second uplink communication 510 may be scheduled or configured on one or more second wireless communication carriers, configured for the UE 120, that are different from the first one or more wireless communication carriers.

Accordingly, at 615, the UE 120 may perform a carrier switch in which the UE 120 switches one or more Tx chains 402 of the UE 120 from the one or more first wireless communication carriers to the second one or more wireless communication carriers. The UE 120 may perform the carrier switch using the communication manager 140, the transmit processor 264, the controller/processor 280, one or more Tx chains 402, and/or a transmission component 1204 described in connection with FIG. 12, among other examples.

This carrier switch may be performed during an uplink transmit switching period 515. The UE 120 may determine the uplink transmit switching period location for the carrier switch based at least in part on one or more of the uplink transmit switching configurations received from one or more network nodes 110. As an example, the UE 120 may identify, in an uplink transmit switching configuration, a wireless communication carrier combination that includes the one or more first wireless communication carriers and the one or more second wireless communication carriers.

The UE 120 may further identify, in the uplink transmit switching configuration, an indication of the uplink transmit switching period location for the wireless communication carrier combination. The UE 120 may perform the carrier switch on the wireless communication carrier(s) indicated by the uplink transmit switching period location. In other words, the UE 120 performs the carrier switch on the timeline for the wireless communication carrier(s) indicated by the uplink transmit switching period location. This may result in the UE 120 dropping at least a portion of the first uplink communication 505 or the second uplink communication 510 to perform the carrier switch, based at least in part on the uplink transmit switching period location indicated in the uplink transmit switching configuration.

If a plurality of uplink transmit switching configurations include the wireless communication carrier combination that includes the one or more first wireless communication carriers and the one or more second wireless communication carriers, and two or more of the plurality of uplink transmit switching configurations indicate different uplink transmit switching period locations for the wireless communication carrier combination, the UE 120 may resolve the conflict based at least in part on one or more of the priority parameters described above.

At 620, the UE 120 may transmit (and a network node 110 may receive) the second uplink communication 510 on one or more second wireless communication carriers configured for the UE 120. The UE 120 may transmit the second uplink communication 510 using the communication manager 140, the transmit processor 264, the controller/processor 280, one or more Tx chains 402, and/or a transmission component 1204 described in connection with FIG. 12, among other examples. The network node 110 may receive the second uplink communication 510 using the communication manager 150, the receive processor 238, the controller/processor 240, one or more Rx chains 404, and/or a reception component 1302 described in connection with FIG. 13, among other examples.

The UE 120 may transmit (and a network node 110 may receive) the second uplink communication 510 on one or more second wireless communication carriers after performing the carrier switch to switch one or more Tx chains 402 of the UE 120 from the one or more first wireless communication carriers to the one or more second wireless communication carriers.

In some cases, a network node 110 may transmit (and the UE 120 may receive) an RRC parameter {oneT, twoT} (e.g., via an uplinkTxSwitching-DualUL-TxState information element) to indicate a target switching case for resolving switching ambiguity in implementations in which the UE 120 includes two Tx chains 402. oneT may indicate that an uplink communication is to be transmitted with only one of the two Tx chains 402, whereas twoT may indicate that an uplink communication is to be transmitted with both of the two Tx chains 402. A switching ambiguity may occur where the UE 120 is scheduled or configured with only one antenna port, and a carrier switch is scheduled. In these cases, the target switching is not unique, thereby resulting in switching ambiguity. For example, the UE 120 may transmit the first plink communication at 610 using the two Tx chains 402 on the one or more first wireless communication carrier, and may switch to a single second wireless communication carrier for transmission the second uplink communication 510 on which only a single port is scheduled and for which oneT (e.g., one of the two Tx chains 402), which results in a switching ambiguity.

To resolve such switching ambiguity, the UE 120 may follow the actual switching band to determine the switching period location, even though there may be no actual transmission on the associated band. Here, a network node 110 may schedule or configure a dummy wireless communication carrier (e.g., a wireless communication carrier X) in addition to the single second wireless communication carrier for transmission the second uplink communication 510 on which only a single port is scheduled and for which oneT (e.g., one of the two Tx chains 402). This enables the UE 120 to transmit the second uplink communication 510 at 620 on the single second wireless communication band with the single port and using only one of the two Tx chains 402. The UE 120 ignores or disregards the dummy wireless communication carrier and refrains from transmitting any uplink communication on the dummy wireless communication carrier.

As indicated above, FIG. 6 is provided as an example. Other examples may differ from what is described with regard to FIG. 6.

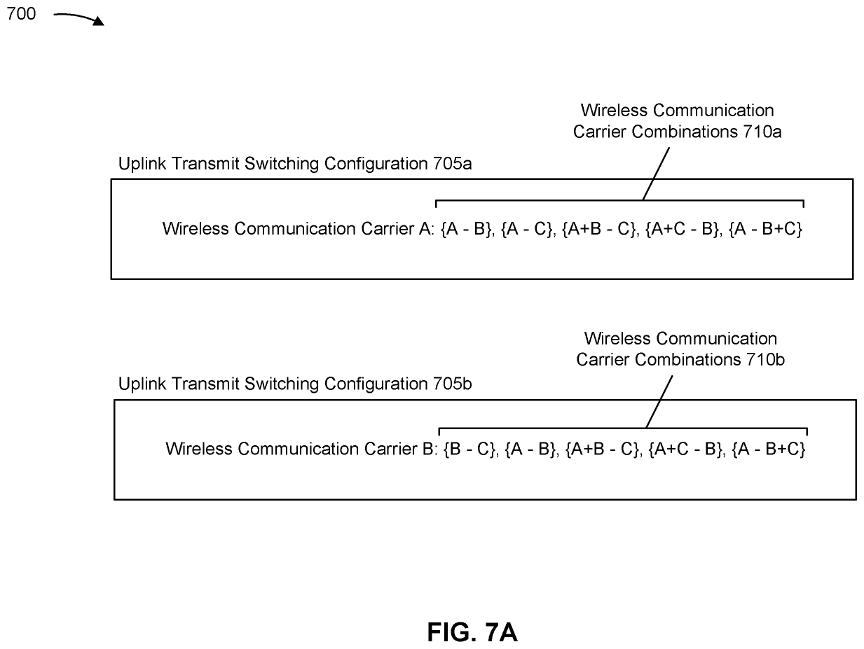

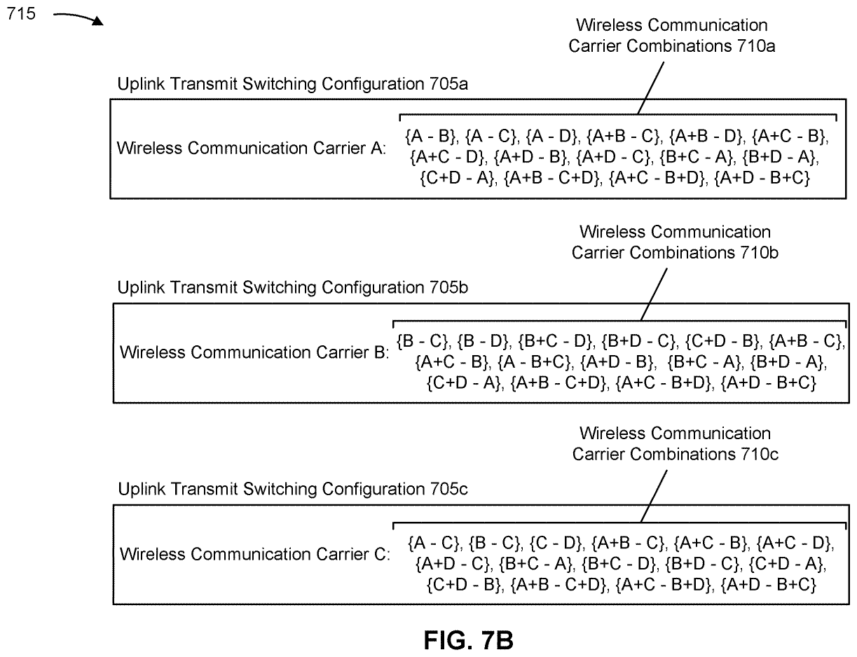

FIGS. 7A and 7B are diagrams of examples of uplink transmit switching configurations, in accordance with the present disclosure. The examples of uplink transmit switching configurations may be used to configure a UE 120 for uplink transmit switching (e.g., carrier switching of the Tx chains 402 of the UE 120). The examples of uplink transmit switching configurations described in connection with FIGS. 7A and 7B may be used in the example 600 described above in connection with FIG. 6. However, other examples of uplink transmit switching configurations are within the scope of the present disclosure.

FIG. 7A illustrates an example 700 of uplink transmit switching configurations that are configured for uplink transmit switching on 3 wireless communication carriers configured for a UE 120: a wireless communication carrier A, a wireless communication carrier B, and a wireless communication carrier C. An uplink transmit switching configuration 705a may be provided to the UE 120 for the wireless communication carrier A, and an uplink transmit switching configuration 705b may be provided to the UE 120 for the wireless communication carrier B.

The uplink transmit switching configuration 705a may include wireless communication carrier combinations 710a that each include the wireless communication carrier A. Thus, the uplink transmit switching configuration 705a does not include wireless communication carrier combinations that do not include the wireless communication carrier A. The uplink transmit switching configuration 705a may further include indications of respective uplink transmit switching period locations for each of the wireless communication carrier combinations 710a.

The uplink transmit switching configuration 705b may include wireless communication carrier combinations 710b that each include the wireless communication carrier B. Thus, the uplink transmit switching configuration 705b does not include wireless communication carrier combinations that do not include the wireless communication carrier B. The uplink transmit switching configuration 705b may further include indications of respective uplink transmit switching period locations for each of the wireless communication carrier combinations 710b.

FIG. 7B illustrates an example 715 of uplink transmit switching configurations that are configured for uplink transmit switching on 4 wireless communication carriers configured for a UE 120: the wireless communication carrier A, the wireless communication carrier B, the wireless communication carrier C, and a wireless communication carrier D. The uplink transmit switching configuration 705a may be provided to the UE 120 for the wireless communication carrier A, the uplink transmit switching configuration 705b may be provided to the UE 120 for the wireless communication carrier B, and an uplink transmit switching configuration 705c may be provided to the UE 120 for the wireless communication carrier C.

The uplink transmit switching configuration 705a may include wireless communication carrier combinations 710a that each include the wireless communication carrier A. Thus, the uplink transmit switching configuration 705a does not include wireless communication carrier combinations that do not include the wireless communication carrier A. The uplink transmit switching configuration 705a may further include indications of respective uplink transmit switching period locations for each of the wireless communication carrier combinations 710a.

The uplink transmit switching configuration 705b may include wireless communication carrier combinations 710b that each include the wireless communication carrier B. Thus, the uplink transmit switching configuration 705b does not include wireless communication carrier combinations that do not include the wireless communication carrier B. The uplink transmit switching configuration 705b may further include indications of respective uplink transmit switching period locations for each of the wireless communication carrier combinations 710b.

The uplink transmit switching configuration 705c may include wireless communication carrier combinations 710c that each include the wireless communication carrier C. Thus, the uplink transmit switching configuration 705c does not include wireless communication carrier combinations that do not include the wireless communication carrier C. The uplink transmit switching configuration 705c may further include indications of respective uplink transmit switching period locations for each of the wireless communication carrier combinations 710c.

As indicated above, FIGS. 7A and 7B are provided as examples. Other examples may differ from what is described with regard to FIGS. 7A and 7B.

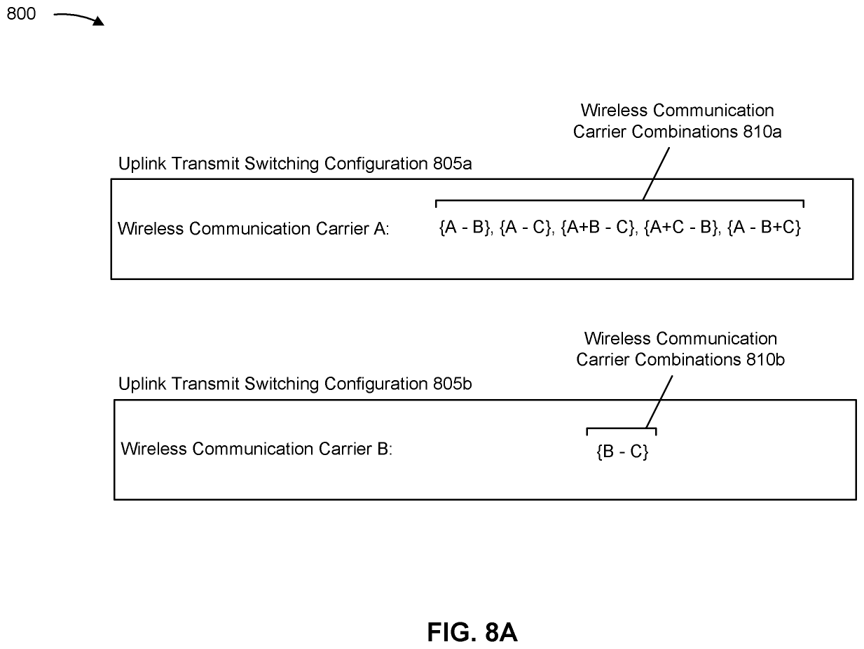

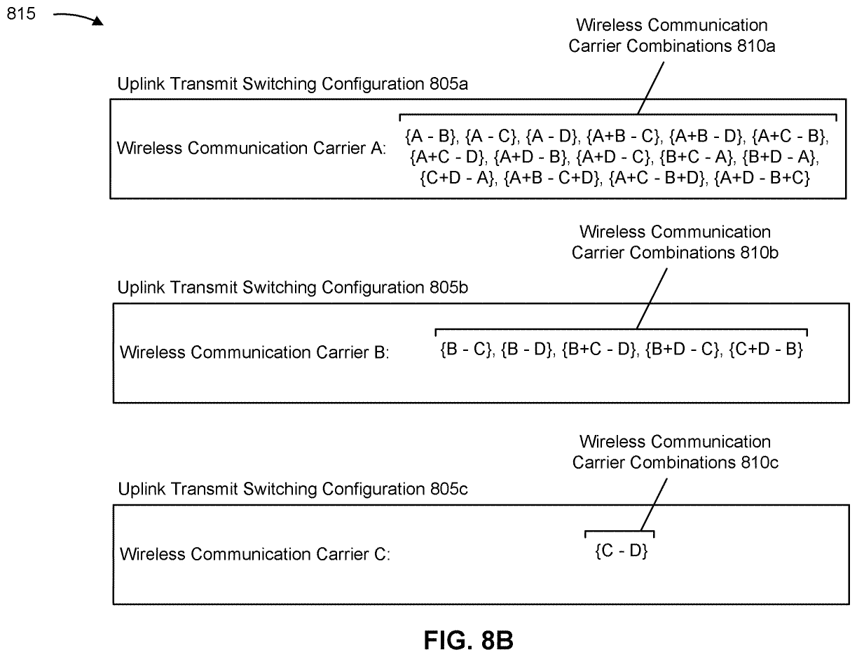

FIGS. 8A and 8B are diagrams of examples of uplink transmit switching configurations, in accordance with the present disclosure. The examples of uplink transmit switching configurations may be used to configure the UE 120 for uplink transmit switching (e.g., carrier switching of the Tx chains 402 of the UE 120). Moreover, the examples of uplink transmit switching configurations illustrated in FIGS. 8A and 8B may be provided to the UE 120 to implicitly indicate priority for resolving conflicts. In the examples of uplink transmit switching configurations illustrated in FIGS. 8A and 8B, the implicit indication of priority is based at least in part on the wireless communication carrier combinations included in the uplink transmit switching configurations. The examples of uplink transmit switching configurations described in connection with FIGS. 8A and 8B may be used in the example 600 described above in connection with FIG. 6. However, other examples of uplink transmit switching configurations are within the scope of the present disclosure.

FIG. 8A illustrates an example 800 of uplink transmit switching configurations that are configured for uplink transmit switching on 3 wireless communication carriers configured for a UE 120: a wireless communication carrier A, a wireless communication carrier B, and a wireless communication carrier C. An uplink transmit switching configuration 805a may be provided to the UE 120 for the wireless communication carrier A, and an uplink transmit switching configuration 805b may be provided to the UE 120 for the wireless communication carrier B.

The uplink transmit switching configuration 805a may include wireless communication carrier combinations 810a that each include the wireless communication carrier A. Thus, the uplink transmit switching configuration 805a does not include wireless communication carrier combinations that do not include the wireless communication carrier A. The uplink transmit switching configuration 805a may further include indications of respective uplink transmit switching period locations for each of the wireless communication carrier combinations 810a.

The uplink transmit switching configuration 805b may include wireless communication carrier combinations 810b that each include the wireless communication carrier B. Thus, the uplink transmit switching configuration 805b does not include wireless communication carrier combinations that do not include the wireless communication carrier B. The uplink transmit switching configuration 805b may further include indications of respective uplink transmit switching period locations for each of the wireless communication carrier combinations 810b.

As further shown in FIG. 8A, the wireless communication carrier combinations 810b differ from the wireless communication carrier combinations 710b shown in FIG. 7A in that the wireless communication carrier combinations 810b do not include duplicative or redundant wireless communication carrier combinations that are already included in the wireless communication carrier combinations 810a. In other words, the wireless communication carrier combinations that are included in the wireless communication carrier combinations 810a are exclusive to the wireless communication carrier combinations 810a (e.g., {A−B}, {A−C}, {A+B−C}, {A+C−B}, {A−B+C}), and the wireless communication carrier combinations that are included in the wireless communication carrier combinations 810b are exclusive to the wireless communication carrier combinations 810b (e.g., {B−C}).

A network node 110 may configure the uplink transmit switching configuration 805a prior to the uplink transmit switching configuration 805b. Thus, the uplink transmit switching configuration 805a includes all wireless communication carrier combinations in which the wireless communication carrier A is included, and the uplink transmit switching configuration 805b includes remaining wireless communication carrier combinations that include the wireless communication carrier B, but not the wireless communication carrier A. In this way, any particular wireless communication carrier combination is included in only one uplink transmit switching configuration, thereby preventing or resolving potential conflicts.

FIG. 8B illustrates an example 815 of uplink transmit switching configurations that are configured for uplink transmit switching on 4 wireless communication carriers configured for a UE 120: the wireless communication carrier A, the wireless communication carrier B, the wireless communication carrier C, and a wireless communication carrier D. The uplink transmit switching configuration 805a may be provided to the UE 120 for the wireless communication carrier A, the uplink transmit switching configuration 805b may be provided to the UE 120 for the wireless communication carrier B, and an uplink transmit switching configuration 805c may be provided to the UE 120 for the wireless communication carrier C.

The uplink transmit switching configuration 805a may include wireless communication carrier combinations 810a that each include the wireless communication carrier A. Thus, the uplink transmit switching configuration 805a does not include wireless communication carrier combinations that do not include the wireless communication carrier A. The uplink transmit switching configuration 805a may further include indications of respective uplink transmit switching period locations for each of the wireless communication carrier combinations 810a.

The uplink transmit switching configuration 805b may include wireless communication carrier combinations 810b that each include the wireless communication carrier B. Thus, the uplink transmit switching configuration 805b does not include wireless communication carrier combinations that do not include the wireless communication carrier B. The uplink transmit switching configuration 805b may further include indications of respective uplink transmit switching period locations for each of the wireless communication carrier combinations 810b.

The uplink transmit switching configuration 805c may include wireless communication carrier combinations 810c that each include the wireless communication carrier C. Thus, the uplink transmit switching configuration 805c does not include wireless communication carrier combinations that do not include the wireless communication carrier C. The uplink transmit switching configuration 805c may further include indications of respective uplink transmit switching period locations for each of the wireless communication carrier combinations 810c.

As further shown in FIG. 8B, the wireless communication carrier combinations 810b differ from the wireless communication carrier combinations 710b shown in FIG. 7B in that the wireless communication carrier combinations 810c do not include duplicative or redundant wireless communication carrier combinations that are already included in the wireless communication carrier combinations 810a. The wireless communication carrier combinations 810c differ from the wireless communication carrier combinations 710c in that the wireless communication carrier combinations 810c do not include duplicative or redundant wireless communication carrier combinations that are already included in the wireless communication carrier combinations 810a and in the wireless communication carrier combinations 810b. In other words, the wireless communication carrier combinations that are included in the wireless communication carrier combinations 810a are exclusive to the wireless communication carrier combinations 810a (e.g., {A−B}, {A−C}, {A−D}, {A+B−C}, {A+B−D}, {A+C−B}, {A+C−D}, {A+D−B}, {A+D−C}, {B+C−A}, {B+D−A}, {C+D−A}, {A+B C+D}, {A+C−B+D}, {A+D−B+C}). The wireless communication carrier combinations that are included in the wireless communication carrier combinations 810b are exclusive to the wireless communication carrier combinations 810b (e.g., {B−C}, {B−D}, {B+C−D}, {B+D−C}, {C+D−B}). The wireless communication carrier combinations that are included in the wireless communication carrier combinations 810c are exclusive to the wireless communication carrier combinations 810c (e.g., {C−D}).

A network node 110 may configure the uplink transmit switching configuration 805a prior to the uplink transmit switching configuration 805b and the uplink transmit switching configuration 805c. Thus, the uplink transmit switching configuration 805a includes all wireless communication carrier combinations in which the wireless communication carrier A is included. The uplink transmit switching configuration 805b includes remaining wireless communication carrier combinations that include the wireless communication carrier B but not the wireless communication carrier A. The uplink transmit switching configuration 805c includes remaining wireless communication carrier combinations that include the wireless communication carrier C but not the wireless communication carrier A or the wireless communication carrier B. In this way, any particular wireless communication carrier combination is included in only one uplink transmit switching configuration, thereby preventing or resolving potential conflicts.

As indicated above, FIGS. 8A and 8B are provided as examples. Other examples may differ from what is described with regard to FIGS. 8A and 8B.

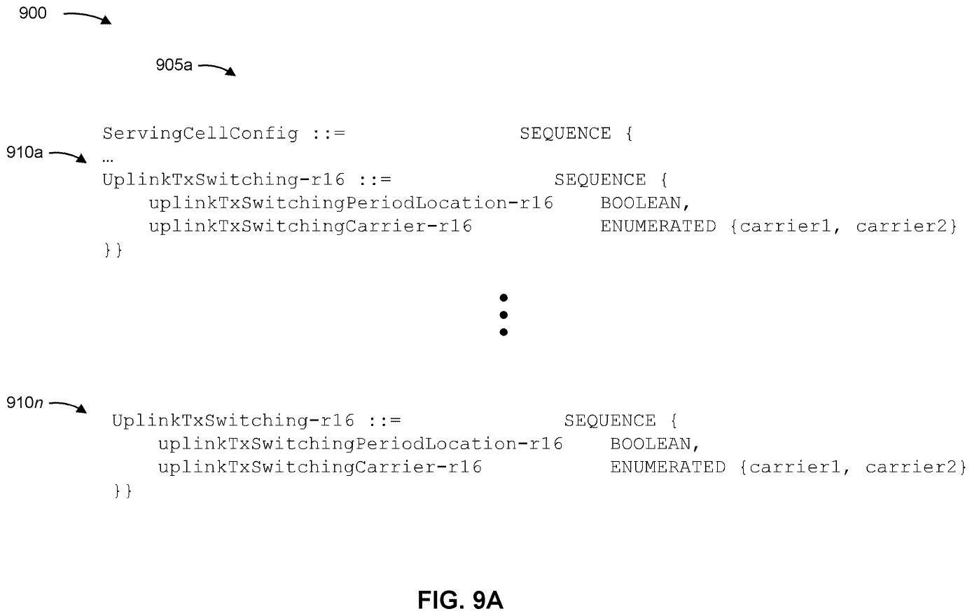

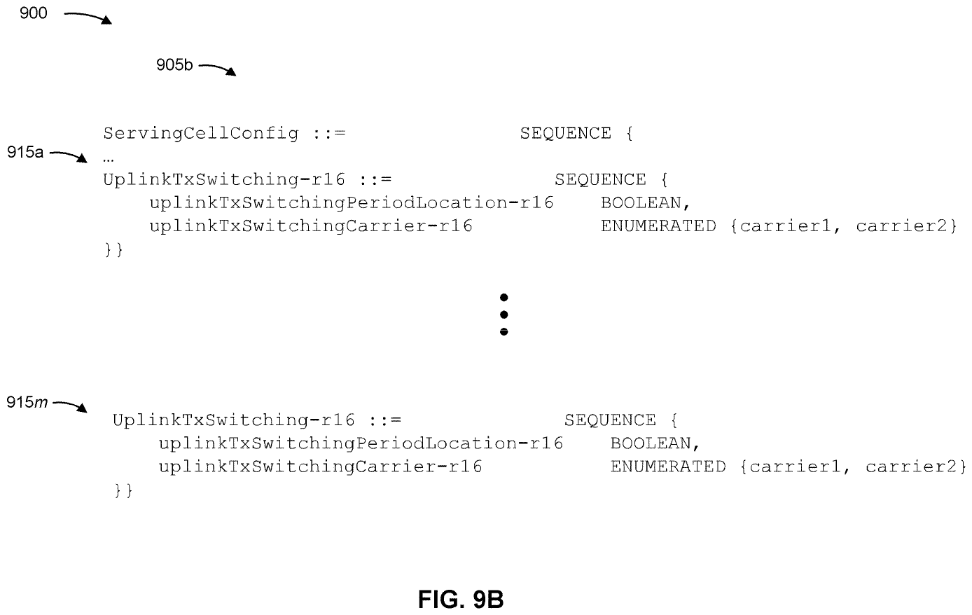

FIGS. 9A and 9B are diagrams of an example 900 of downlink signaling for transmitting uplink transmit switching configurations, in accordance with the present disclosure. The example downlink signaling may be used to configure a UE 120 for uplink transmit switching (e.g., carrier switching of the Tx chains 402 of the UE 120). The example downlink signaling fields described in connection with FIGS. 9A and 9B may be transmitted to a UE 120 in one or more downlink communications in connection with 605 in the example 600 described above in connection with FIG. 6. However, other examples of downlink signaling fields are within the scope of the present disclosure.

FIG. 9A, illustrates example downlink signaling for transmitting an uplink transmit switching configuration 905a associated with a first wireless communication carrier configured for the UE 120. FIG. 9B, illustrates example downlink signaling for transmitting an uplink transmit switching configuration 905b associated with a second wireless communication carrier configured for the UE 120. Thus, the example 900 includes an example in which the UE 120 is scheduled or configured for uplink transmit switching on 3 wireless communication carriers. Additional sets of downlink signaling fields may be transmitted to the UE 120 for scheduling or configuring the UE 120 for uplink transmit switching on additional wireless communication carriers.

As shown in FIGS. 9A and 9B, an uplink transmit switching configuration (e.g., the uplink transmit switching configuration 905a, the uplink transmit switching configuration 905b) may include, or may be included in, a serving cell configuration for the corresponding uplink wireless communication carrier. Additionally and/or alternatively, an uplink transmit switching configuration (e.g., the uplink transmit switching configuration 905a, the uplink transmit switching configuration 905b) may include, or may be included in, another field or information element in a downlink communication.

As further shown in FIGS. 9A and 9B, an uplink transmit switching configuration may include one or more uplink transmit switching fields or information elements (e.g., UplinkTxSwitching, UplinkTxSwitching-r16). For example, the uplink transmit switching configuration 905a may include one or more uplink transmit switching fields 910a-910n, and the uplink transmit switching configuration 905b may include one or more uplink transmit switching fields 915a-915m. Each uplink transmit switching field may include a wireless communication carrier combination and an uplink transmit switching period location for the wireless communication carrier combination.

As shown in FIGS. 9A and 9B, an uplink transmit switching period location may be indicated in a field or information element (e.g., uplink TxSwitchingPeriodLocation, uplinkTxSwitchingPeriodLocation-r16). The field may include a Boolean field that is configured to include a TRUE flag or a FALSE flag. A wireless communication carrier combination may be indicated in a field or information element (e.g., uplinkTxSwitchingCarrier, uplinkTxSwitchingCarrier-r16). In the field, the wireless communication carrier may be enumerated as {carrier1, carrier2}, where carrier1 corresponds to one or more first wireless communication carriers, and carrier2 corresponds to one or more second wireless communication carriers.

A TRUE flag in the Boolean field of the uplink transmit switching period location may indicate that an uplink transmit switching period location corresponds to the first wireless communication carrier (carrier1), whereas a FALSE flag in the Boolean field of the uplink transmit switching period location may indicate that the uplink transmit switching period location corresponds to the second wireless communication carrier (carrier2). Alternatively, a TRUE flag in the Boolean field of the uplink transmit switching period location may indicate that an uplink transmit switching period location corresponds to the second wireless communication carrier (carrier2), whereas a FALSE flag in the Boolean field of the uplink transmit switching period location may indicate that the uplink transmit switching period location corresponds to the first wireless communication carrier (carrier1).

As indicated above, FIGS. 9A and 9B are provided as examples. Other examples may differ from what is described with regard to FIGS. 9A and 9B.

FIG. 10 is a diagram illustrating an example process 1000 performed, for example, by a UE, in accordance with the present disclosure. Example process 1000 is an example where the UE (e.g., UE 120) performs operations associated with indicating a switching period location for uplink transmit switching.

As shown in FIG. 10, in some aspects, process 1000 may include receiving, for a first wireless communication carrier, a first uplink transmit switching configuration that indicates a first plurality of wireless communication carrier combinations, wherein the first wireless communication carrier is included in each of the first plurality of wireless communication carrier combinations (block 1010). For example, the UE (e.g., using reception component 1202 and/or communication manager 140, depicted in FIG. 12) may receive, for a first wireless communication carrier, a first uplink transmit switching configuration that indicates a first plurality of wireless communication carrier combinations, wherein the first wireless communication carrier is included in each of the first plurality of wireless communication carrier combinations, as described above. In some aspects, the first wireless communication carrier is included in each of the first plurality of wireless communication carrier combinations.

As further shown in FIG. 10, in some aspects, process 1000 may include receiving, for a second wireless communication carrier, a second uplink transmit switching configuration that indicates a second plurality of wireless communication carrier combinations, wherein the second wireless communication carrier is included in each of the second plurality of wireless communication carrier combinations (block 1020). For example, the UE (e.g., using reception component 1202 and/or communication manager 140, depicted in FIG. 12) may receive, for a second wireless communication carrier, a second uplink transmit switching configuration that indicates a second plurality of wireless communication carrier combinations, wherein the second wireless communication carrier is included in each of the second plurality of wireless communication carrier combinations, as described above. In some aspects, the second wireless communication carrier is included in each of the second plurality of wireless communication carrier combinations.

Process 1000 may include additional aspects, such as any single aspect or any combination of aspects described below and/or in connection with one or more other processes described elsewhere herein.

In a first aspect, a wireless communication carrier combination, of the first plurality of wireless communication carrier combinations, includes the first wireless communication carrier, and at least one of the second wireless communication carrier, or a third wireless communication carrier. In a second aspect, alone or in combination with the first aspect, process 1000 includes receiving, for a third wireless communication carrier, a third uplink transmit switching configuration that indicates a third plurality of wireless communication carrier combinations, wherein the third wireless communication carrier is included in each of the third plurality of wireless communication carrier combinations. In a third aspect, alone or in combination with one or more of the first and second aspects, the first uplink transmit switching configuration indicates an uplink transmit period location for a wireless communication carrier combination of the first plurality of wireless communication carrier combinations.

In a fourth aspect, alone or in combination with one or more of the first through third aspects, the UE is configured for uplink transmit switching associated with three or more wireless communication carriers, including the first wireless communication carrier and the second wireless communication carrier. In a fifth aspect, alone or in combination with one or more of the first through fourth aspects, process 1000 includes receiving a downlink communication that explicitly indicates a wireless communication carrier priority for resolving uplink transmit switching period location conflicts between the first uplink transmit switching configuration and the second uplink transmit switching configuration. In a sixth aspect, alone or in combination with one or more of the first through fifth aspects, the downlink communication comprises at least one of an RRC communication, a MAC-CE communication, or a DCI communication.

In a seventh aspect, alone or in combination with one or more of the first through sixth aspects, process 1000 includes receiving a downlink communication that explicitly indicates a priority order, of wireless communication carriers configured for the UE, for resolving uplink transmit switching period location conflicts between the first uplink transmit switching configuration and the second uplink transmit switching configuration. In an eighth aspect, alone or in combination with one or more of the first through seventh aspects, process 1000 includes receiving a downlink communication that explicitly indicates respective wireless communication carrier priorities, for each pair combination of wireless communication carriers configured for the UE, for resolving uplink transmit switching period location conflicts between each pair combination of wireless communication carriers configured for the UE.

In a ninth aspect, alone or in combination with one or more of the first through eighth aspects, the first wireless communication carrier is included in only the first plurality of wireless communication carrier combinations and is not included in any of the second plurality of wireless communication carrier combinations. In a tenth aspect, alone or in combination with one or more of the first through ninth aspects, process 1000 includes receiving, for a third wireless communication carrier, a third uplink transmit switching configuration that indicates a third plurality of wireless communication carrier combinations, wherein the third wireless communication carrier is included in each of the third plurality of wireless communication carrier combinations, wherein the first wireless communication carrier is included in only the first plurality of wireless communication carrier combinations, is not included in any of the second plurality of wireless communication carrier combinations, and is not included in any of the third plurality of wireless communication carrier combinations, and wherein the second wireless communication carrier is not included in one or more of the first plurality of wireless communication carrier combinations and is not included in any of the third plurality of wireless communication carrier combinations.

In an eleventh aspect, alone or in combination with one or more of the first through tenth aspects, a single antenna port is scheduled for the UE, and the process 1000 includes receiving an RRC communication indicating the UE is to switching two transmit chains of the UE to the first wireless communication carrier, and performing, using the two transmit chains, an uplink transmission on the first wireless communication carrier. In a twelfth aspect, alone or in combination with one or more of the first through eleventh aspects, the first plurality of wireless communication carrier combinations and the second plurality of wireless communication carrier combinations both include a wireless communication carrier combination that includes the first wireless communication carrier and the second wireless communication carrier, the first uplink transmit switching configuration includes an indication that an uplink transmit switching period location is to occur on the first wireless communication carrier for the wireless communication carrier combination that includes the first wireless communication carrier and the second wireless communication carrier, the second uplink transmit switching configuration includes an indication that the uplink transmit switching period location is to occur on the second wireless communication carrier for the wireless communication carrier combination that includes the first wireless communication carrier and the second wireless communication carrier, and process 1000 includes determining that the uplink transmit switching period location is to occur on the first wireless communication carrier based at least in part on a first switching period duration for the first wireless communication carrier being greater than a second switching period duration for the second wireless communication carrier.

In a thirteenth aspect, alone or in combination with one or more of the first through twelfth aspects, the first plurality of wireless communication carrier combinations and the second plurality of wireless communication carrier combinations both include a wireless communication carrier combination that includes the first wireless communication carrier and the second wireless communication carrier, the first uplink transmit switching configuration includes an indication that an uplink transmit switching period location is to occur on the first wireless communication carrier for the wireless communication carrier combination that includes the first wireless communication carrier and the second wireless communication carrier, the second uplink transmit switching configuration includes an indication that the uplink transmit switching period location is to occur on the second wireless communication carrier for the wireless communication carrier combination that includes the first wireless communication carrier and the second wireless communication carrier, and process 1000 includes determining that the uplink transmit switching period location is to occur on the first wireless communication carrier based at least in part on a UE implementation of the UE.

In a fourteenth aspect, alone or in combination with one or more of the first through thirteenth aspects, a single antenna port is scheduled for the UE, and process 1000 includes receiving an RRC communication indicating the UE is to switching a first transmit chain of the UE to the first wireless communication carrier, switching a second transmit chain of the UE to a third wireless communication carrier, performing, using the first transmit chain, an uplink transmission on the first wireless communication carrier, and refraining from performing any uplink transmissions on the third wireless communication carrier.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110) performs operations associated with indicating a switching period location for uplink transmit switching.

As shown in FIG. 11, in some aspects, process 1100 may include transmitting, for a first wireless communication carrier, a first uplink transmit switching configuration that indicates a first plurality of wireless communication carrier combinations, wherein the first wireless communication carrier is included in each of the first plurality of wireless communication carrier combinations (block 1110). For example, the network node (e.g., using transmission component 1304 and/or communication manager 150, depicted in FIG. 13) may transmit, for a first wireless communication carrier, a first uplink transmit switching configuration that indicates a first plurality of wireless communication carrier combinations, wherein the first wireless communication carrier is included in each of the first plurality of wireless communication carrier combinations, as described above. In some aspects, the first wireless communication carrier is included in each of the first plurality of wireless communication carrier combinations.

As further shown in FIG. 11, in some aspects, process 1100 may include transmitting, for a second wireless communication carrier, a second uplink transmit switching configuration that indicates a second plurality of wireless communication carrier combinations, wherein the second wireless communication carrier is included in each of the second plurality of wireless communication carrier combinations (block 1120). For example, the network node (e.g., using transmission component 1304 and/or communication manager 150, depicted in FIG. 13) may transmit, for a second wireless communication carrier, a second uplink transmit switching configuration that indicates a second plurality of wireless communication carrier combinations, wherein the second wireless communication carrier is included in each of the second plurality of wireless communication carrier combinations, as described above. In some aspects, the second wireless communication carrier is included in each of the second plurality of wireless communication carrier combinations.

Process 1100 may include additional aspects, such as any single aspect or any combination of aspects described below and/or in connection with one or more other processes described elsewhere herein.

In a first aspect, a wireless communication carrier combination, of the first plurality of wireless communication carrier combinations, includes the first wireless communication carrier, and at least one of the second wireless communication carrier, or a third wireless communication carrier. In a second aspect, alone or in combination with the first aspect, process 1100 includes transmitting, for a third wireless communication carrier, a third uplink transmit switching configuration that indicates a third plurality of wireless communication carrier combinations, wherein the third wireless communication carrier is included in each of the third plurality of wireless communication carrier combinations. In a third aspect, alone or in combination with one or more of the first and second aspects, the first uplink transmit switching configuration indicates an uplink transmit period location for a wireless communication carrier combination of the first plurality of wireless communication carrier combinations.

In a fourth aspect, alone or in combination with one or more of the first through third aspects, transmitting the first uplink transmit switching configuration comprises transmitting the first uplink transmit switching configuration to a UE, and transmitting the second uplink transmit switching configuration comprises transmitting the second uplink transmit switching configuration to the UE, wherein the UE is configured for uplink transmit switching associated with three or more wireless communication carriers, including the first wireless communication carrier and the second wireless communication carrier. In a fifth aspect, alone or in combination with one or more of the first through fourth aspects, process 1100 includes transmitting a downlink communication that explicitly indicates a wireless communication carrier priority for resolving uplink transmit switching period location conflicts between the first uplink transmit switching configuration and the second uplink transmit switching configuration.

In a sixth aspect, alone or in combination with one or more of the first through fifth aspects, the downlink communication comprises at least one of an RRC communication, a MAC-CE communication, or a DCI communication. In a seventh aspect, alone or in combination with one or more of the first through sixth aspects, process 1100 includes transmitting a downlink communication that explicitly indicates a priority order, of wireless communication carriers configured for a UE, for resolving uplink transmit switching period location conflicts between the first uplink transmit switching configuration and the second uplink transmit switching configuration.

In an eighth aspect, alone or in combination with one or more of the first through seventh aspects, process 1100 includes transmitting a downlink communication that explicitly indicates respective wireless communication carrier priorities, for each pair combination of wireless communication carriers configured for a UE, for resolving uplink transmit switching period location conflicts between each pair combination of wireless communication carriers configured for the UE. In a ninth aspect, alone or in combination with one or more of the first through eighth aspects, the first wireless communication carrier is included in only the first plurality of wireless communication carrier combinations and is not included in any of the second plurality of wireless communication carrier combinations.

In a tenth aspect, alone or in combination with one or more of the first through ninth aspects, process 1100 includes transmitting, for a third wireless communication carrier, a third uplink transmit switching configuration that indicates a third plurality of wireless communication carrier combinations, wherein the third wireless communication carrier is included in each of the third plurality of wireless communication carrier combinations, wherein the first wireless communication carrier is included in only the first plurality of wireless communication carrier combinations, is not included in any of the second plurality of wireless communication carrier combinations, and is not included in any of the third plurality of wireless communication carrier combinations, and wherein the second wireless communication carrier is not included in one or more of the first plurality of wireless communication carrier combinations and is not included in any of the third plurality of wireless communication carrier combinations. In an eleventh aspect, alone or in combination with one or more of the first through tenth aspects, process 1100 includes transmitting, to a UE that is scheduled with a single antenna port, an RRC communication indicating the UE is to switching two transmit chains of the UE to the first wireless communication carrier, and performing, using the two transmit chains, an uplink transmission on the first wireless communication carrier.

In a twelfth aspect, alone or in combination with one or more of the first through eleventh aspects, process 1100 includes transmitting, to a UE that is scheduled with a single antenna port, an RRC communication indicating the UE is to switching a first transmit chain of the UE to the first wireless communication carrier, switching a second transmit chain of the UE to a third wireless communication carrier, performing, using the first transmit chain, an uplink transmission on the first wireless communication carrier, and refraining from performing any uplink transmissions on the third wireless communication carrier.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202, a transmission component 1204, and/or a communication manager 140, which may be in communication with one another (for example, via one or more buses and/or one or more other components). As shown, the apparatus 1200 may communicate with another apparatus 1206, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 5A-9B. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The communication manager 140 may support operations of the reception component 1202 and/or the transmission component 1204. For example, the communication manager 140 may receive information associated with configuring reception of communications by the reception component 1202 and/or transmission of communications by the transmission component 1204. Additionally, or alternatively, the communication manager 140 may generate and/or provide control information to the reception component 1202 and/or the transmission component 1204 to control reception and/or transmission of communications.

The reception component 1202 may receive (e.g., from the apparatus 1206), for a first wireless communication carrier, a first uplink transmit switching configuration that indicates a first plurality of wireless communication carrier combinations, wherein the first wireless communication carrier is included in each of the first plurality of wireless communication carrier combinations. The reception component 1202 may receive (e.g., from the apparatus 1206), for a second wireless communication carrier, a second uplink transmit switching configuration that indicates a second plurality of wireless communication carrier combinations, wherein the second wireless communication carrier is included in each of the second plurality of wireless communication carrier combinations.

The reception component 1202 may receive (e.g., from the apparatus 1206), for a third wireless communication carrier, a third uplink transmit switching configuration that indicates a third plurality of wireless communication carrier combinations wherein the third wireless communication carrier is included in each of the third plurality of wireless communication carrier combinations. The reception component 1202 may receive (e.g., from the apparatus 1206) a downlink communication that explicitly indicates a wireless communication carrier priority for resolving uplink transmit switching period location conflicts between the first uplink transmit switching configuration and the second uplink transmit switching configuration.

The reception component 1202 may receive (e.g., from the apparatus 1206) a downlink communication that explicitly indicates a priority order, of wireless communication carriers configured for the apparatus 1200, for resolving uplink transmit switching period location conflicts between the first uplink transmit switching configuration and the second uplink transmit switching configuration. The reception component 1202 may receive (e.g., from the apparatus 1206) a downlink communication that explicitly indicates respective wireless communication carrier priorities, for each pair combination of wireless communication carriers configured for the apparatus 1200, for resolving uplink transmit switching period location conflicts between each pair combination of wireless communication carriers configured for the apparatus 1200.

The reception component 1202 may receive (e.g., from the apparatus 1206), for a third wireless communication carrier, a third uplink transmit switching configuration that indicates a third plurality of wireless communication carrier combinations wherein the third wireless communication carrier is included in each of the third plurality of wireless communication carrier combinations, wherein the first wireless communication carrier is included in only the first plurality of wireless communication carrier combinations, is not included in any of the second plurality of wireless communication carrier combinations, and is not included in any of the third plurality of wireless communication carrier combinations, and wherein the second wireless communication carrier is not included in one or more of the first plurality of wireless communication carrier combinations and is not included in any of the third plurality of wireless communication carrier combinations.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302, a transmission component 1304, and/or a communication manager 150, which may be in communication with one another (for example, via one or more buses and/or one or more other components). As shown, the apparatus 1300 may communicate with another apparatus 1306, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 5A-9B. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2. In some aspects, the reception component 1302 and/or the transmission component 1304 may include or may be included in a network interface. The network interface may be configured to obtain and/or output signals for the apparatus 1300 via one or more communications links, such as a backhaul link, a midhaul link, and/or a fronthaul link.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

The communication manager 150 may support operations of the reception component 1302 and/or the transmission component 1304. For example, the communication manager 150 may receive information associated with configuring reception of communications by the reception component 1302 and/or transmission of communications by the transmission component 1304. Additionally, or alternatively, the communication manager 150 may generate and/or provide control information to the reception component 1302 and/or the transmission component 1304 to control reception and/or transmission of communications.

The transmission component 1304 may transmit (e.g., to the apparatus 1306), for a first wireless communication carrier, a first uplink transmit switching configuration that indicates a first plurality of wireless communication carrier combinations, wherein the first wireless communication carrier is included in each of the first plurality of wireless communication carrier combinations. The transmission component 1304 may transmit (e.g., to the apparatus 1306), for a second wireless communication carrier, a second uplink transmit switching configuration that indicates a second plurality of wireless communication carrier combinations, wherein the second wireless communication carrier is included in each of the second plurality of wireless communication carrier combinations.

The transmission component 1304 may transmit (e.g., to the apparatus 1306), for a third wireless communication carrier, a third uplink transmit switching configuration that indicates a third plurality of wireless communication carrier combinations wherein the third wireless communication carrier is included in each of the third plurality of wireless communication carrier combinations.

The transmission component 1304 may transmit (e.g., to the apparatus 1306) a downlink communication that explicitly indicates a wireless communication carrier priority for resolving uplink transmit switching period location conflicts between the first uplink transmit switching configuration and the second uplink transmit switching configuration.

The transmission component 1304 may transmit (e.g., to the apparatus 1306) a downlink communication that explicitly indicates a priority order, of wireless communication carriers configured for the apparatus 1306, for resolving uplink transmit switching period location conflicts between the first uplink transmit switching configuration and the second uplink transmit switching configuration.

The transmission component 1304 may transmit (e.g., to the apparatus 1306) a downlink communication that explicitly indicates respective wireless communication carrier priorities, for each pair combination of wireless communication carriers configured for the apparatus 1306, for resolving uplink transmit switching period location conflicts between each pair combination of wireless communication carriers configured for the apparatus 1306.

The transmission component 1304 may transmit, for a third wireless communication carrier, a third uplink transmit switching configuration that indicates a third plurality of wireless communication carrier combinations wherein the third wireless communication carrier is included in each of the third plurality of wireless communication carrier combinations, wherein the first wireless communication carrier is included in only the first plurality of wireless communication carrier combinations, is not included in any of the second plurality of wireless communication carrier combinations, and is not included in any of the third plurality of wireless communication carrier combinations, and wherein the second wireless communication carrier is not included in one or more of the first plurality of wireless communication carrier combinations and is not included in any of the third plurality of wireless communication carrier combinations.

The transmission component 1304 may transmit, to the apparatus 1306 that is scheduled with a single antenna port, an RRC communication indicating the 1306 is to switch two transmit chains of the apparatus 1306 to the first wireless communication carrier; and perform, using the two transmit chains, an uplink transmission on the first wireless communication carrier.

The transmission component 1304 may transmit, to the apparatus 1306 that is scheduled with a single antenna port, an RRC communication indicating the apparatus 1306 is to switch a first transmit chain of the apparatus 1306 to the first wireless communication carrier; switch a second transmit chain of the apparatus 1306 to a third wireless communication carrier; perform, using the first transmit chain, an uplink transmission on the first wireless communication carrier; and refrain from performing any uplink transmissions on the third wireless communication carrier.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving, for a first wireless communication carrier, a first uplink transmit switching configuration that indicates a first plurality of wireless communication carrier combinations, wherein the first wireless communication carrier is included in each of the first plurality of wireless communication carrier combinations; and receiving, for a second wireless communication carrier, a second uplink transmit switching configuration that indicates a second plurality of wireless communication carrier combinations, wherein the second wireless communication carrier is included in each of the second plurality of wireless communication carrier combinations.

Aspect 2: The method of Aspect 1, wherein a wireless communication carrier combination, of the first plurality of wireless communication carrier combinations, includes: the first wireless communication carrier; and at least one of: the second wireless communication carrier, or a third wireless communication carrier.

Aspect 3: The method of any of Aspects 1-2, further comprising: receiving, for a third wireless communication carrier, a third uplink transmit switching configuration that indicates a third plurality of wireless communication carrier combinations, wherein the third wireless communication carrier is included in each of the third plurality of wireless communication carrier combinations.

Aspect 4: The method of any of Aspects 1-3, wherein the first uplink transmit switching configuration indicates an uplink transmit period location for a wireless communication carrier combination of the first plurality of wireless communication carrier combinations.

Aspect 5: The method of any of Aspects 1-4, wherein the UE is configured for uplink transmit switching associated with three or more wireless communication carriers, including the first wireless communication carrier and the second wireless communication carrier.

Aspect 6: The method of any of Aspects 1-5, further comprising: receiving a downlink communication that explicitly indicates a wireless communication carrier priority for resolving uplink transmit switching period location conflicts between the first uplink transmit switching configuration and the second uplink transmit switching configuration.

Aspect 7: The method of Aspect 6, wherein the downlink communication comprises at least one of: a radio resource control (RRC) communication, a medium access control (MAC) control element (MAC-CE) communication, or a downlink control information (DCI) communication.

Aspect 8: The method of any of Aspects 1-7, further comprising: receiving a downlink communication that explicitly indicates a priority order, of wireless communication carriers configured for the UE, for resolving uplink transmit switching period location conflicts between the first uplink transmit switching configuration and the second uplink transmit switching configuration.

Aspect 9: The method of any of Aspects 1-8, further comprising: receiving a downlink communication that explicitly indicates respective wireless communication carrier priorities, for each pair combination of wireless communication carriers configured for the UE, for resolving uplink transmit switching period location conflicts between each pair combination of wireless communication carriers configured for the UE.

Aspect 10: The method of any of Aspects 1-9, wherein the first wireless communication carrier is included in only the first plurality of wireless communication carrier combinations and is not included in any of the second plurality of wireless communication carrier combinations.

Aspect 11: The method of any of Aspects 1-10, further comprising: receiving, for a third wireless communication carrier, a third uplink transmit switching configuration that indicates a third plurality of wireless communication carrier combinations, wherein the third wireless communication carrier is included in each of the third plurality of wireless communication carrier combinations, wherein the first wireless communication carrier is included in only the first plurality of wireless communication carrier combinations, is not included in any of the second plurality of wireless communication carrier combinations, and is not included in any of the third plurality of wireless communication carrier combinations, and wherein the second wireless communication carrier is not included in one or more of the first plurality of wireless communication carrier combinations and is not included in any of the third plurality of wireless communication carrier combinations.

Aspect 12: The method of any of Aspects 1-11, wherein a single antenna port is scheduled for the UE; and wherein the method further comprises: receiving a radio resource control (RRC) communication indicating: the UE is to: switch two transmit chains of the UE to the first wireless communication carrier; and perform, using the two transmit chains, an uplink transmission on the first wireless communication carrier.

Aspect 13: The method of any of Aspects 1-12, wherein the first plurality of wireless communication carrier combinations and the second plurality of wireless communication carrier combinations both include a wireless communication carrier combination that includes the first wireless communication carrier and the second wireless communication carrier; wherein the first uplink transmit switching configuration includes an indication that an uplink transmit switching period location is to occur on the first wireless communication carrier for the wireless communication carrier combination that includes the first wireless communication carrier and the second wireless communication carrier; wherein the second uplink transmit switching configuration includes an indication that the uplink transmit switching period location is to occur on the second wireless communication carrier for the wireless communication carrier combination that includes the first wireless communication carrier and the second wireless communication carrier; and wherein the method further comprises: determining that the uplink transmit switching period location is to occur on the first wireless communication carrier based at least in part on a first switching period duration for the first wireless communication carrier being greater than a second switching period duration for the second wireless communication carrier.

Aspect 14: The method of any of Aspects 1-13, wherein the first plurality of wireless communication carrier combinations and the second plurality of wireless communication carrier combinations both include a wireless communication carrier combination that includes the first wireless communication carrier and the second wireless communication carrier; wherein the first uplink transmit switching configuration includes an indication that an uplink transmit switching period location is to occur on the first wireless communication carrier for the wireless communication carrier combination that includes the first wireless communication carrier and the second wireless communication carrier; wherein the second uplink transmit switching configuration includes an indication that the uplink transmit switching period location is to occur on the second wireless communication carrier for the wireless communication carrier combination that includes the first wireless communication carrier and the second wireless communication carrier; and wherein the method further comprises: determining that the uplink transmit switching period location is to occur on the first wireless communication carrier based at least in part on a UE implementation of the UE.

Aspect 15: The method of any of Aspects 1-14, wherein a single antenna port is scheduled for the UE; and wherein the method further comprises: receiving a radio resource control (RRC) communication indicating: the UE is to: switch a first transmit chain of the UE to the first wireless communication carrier; switch a second transmit chain of the UE to a third wireless communication carrier; perform, using the first transmit chain, an uplink transmission on the first wireless communication carrier; and refrain from performing any uplink transmissions on the third wireless communication carrier.

Aspect 16: A method of wireless communication performed by a network node, comprising: transmitting, for a first wireless communication carrier, a first uplink transmit switching configuration that indicates a first plurality of wireless communication carrier combinations, wherein the first wireless communication carrier is included in each of the first plurality of wireless communication carrier combinations; and transmitting, for a second wireless communication carrier, a second uplink transmit switching configuration that indicates a second plurality of wireless communication carrier combinations, wherein the second wireless communication carrier is included in each of the second plurality of wireless communication carrier combinations.

Aspect 17: The method of Aspect 16, wherein a wireless communication carrier combination, of the first plurality of wireless communication carrier combinations, includes: the first wireless communication carrier; and at least one of: the second wireless communication carrier, or a third wireless communication carrier.

Aspect 18: The method of any of Aspects 16-17, further comprising: transmitting, for a third wireless communication carrier, a third uplink transmit switching configuration that indicates a third plurality of wireless communication carrier combinations, wherein the third wireless communication carrier is included in each of the third plurality of wireless communication carrier combinations.

Aspect 19: The method of any of Aspects 16-18, wherein the first uplink transmit switching configuration indicates an uplink transmit period location for a wireless communication carrier combination of the first plurality of wireless communication carrier combinations.

Aspect 20: The method of any of Aspects 16-19, wherein transmitting the first uplink transmit switching configuration comprises: transmitting the first uplink transmit switching configuration to a user equipment (UE); and wherein transmitting the second uplink transmit switching configuration comprises: transmitting the second uplink transmit switching configuration to the UE, wherein the UE is configured for uplink transmit switching associated with three or more wireless communication carriers, including the first wireless communication carrier and the second wireless communication carrier.

Aspect 21: The method of any of Aspects 16-20, further comprising: transmitting a downlink communication that explicitly indicates a wireless communication carrier priority for resolving uplink transmit switching period location conflicts between the first uplink transmit switching configuration and the second uplink transmit switching configuration.

Aspect 22: The method of Aspect 21, wherein the downlink communication comprises at least one of: a radio resource control (RRC) communication, a medium access control (MAC) control element (MAC-CE) communication, or a downlink control information (DCI) communication.

Aspect 23: The method of any of Aspects 16-22, further comprising: transmitting a downlink communication that explicitly indicates a priority order, of wireless communication carriers configured for a user equipment (UE), for resolving uplink transmit switching period location conflicts between the first uplink transmit switching configuration and the second uplink transmit switching configuration.

Aspect 24: The method of any of Aspects 16-23, further comprising: transmitting a downlink communication that explicitly indicates respective wireless communication carrier priorities, for each pair combination of wireless communication carriers configured for a user equipment (UE), for resolving uplink transmit switching period location conflicts between each pair combination of wireless communication carriers configured for the UE.

Aspect 25: The method of any of Aspects 16-24, wherein the first wireless communication carrier is included in only the first plurality of wireless communication carrier combinations and is not included in any of the second plurality of wireless communication carrier combinations.

Aspect 26: The method of any of Aspects 16-25, further comprising: transmitting, for a third wireless communication carrier, a third uplink transmit switching configuration that indicates a third plurality of wireless communication carrier combinations, wherein the third wireless communication carrier is included in each of the third plurality of wireless communication carrier combinations, wherein the first wireless communication carrier is included in only the first plurality of wireless communication carrier combinations, is not included in any of the second plurality of wireless communication carrier combinations, and is not included in any of the third plurality of wireless communication carrier combinations, and wherein the second wireless communication carrier is not included in one or more of the first plurality of wireless communication carrier combinations and is not included in any of the third plurality of wireless communication carrier combinations.

Aspect 27: The method of any of Aspects 16-26, further comprising: transmitting, to a user equipment (UE) that is scheduled with a single antenna port, a radio resource control (RRC) communication indicating: the UE is to: switch two transmit chains of the UE to the first wireless communication carrier; and perform, using the two transmit chains, an uplink transmission on the first wireless communication carrier.

Aspect 28: The method of any of Aspects 16-27, further comprising: transmitting, to a user equipment (UE) that is scheduled with a single antenna port, a radio resource control (RRC) communication indicating: the UE is to: switch a first transmit chain of the UE to the first wireless communication carrier; switch a second transmit chain of the UE to a third wireless communication carrier; perform, using the first transmit chain, an uplink transmission on the first wireless communication carrier; and refrain from performing any uplink transmissions on the third wireless communication carrier.

Aspect 29: An apparatus for wireless communication at a device, comprising a processor; memory coupled with the processor; and instructions stored in the memory and executable by the processor to cause the apparatus to perform the method of one or more of Aspects 1-28.

Aspect 30: A device for wireless communication, comprising a memory and one or more processors coupled to the memory, the one or more processors configured to perform the method of one or more of Aspects 1-28.

Aspect 31: An apparatus for wireless communication, comprising at least one means for performing the method of one or more of Aspects 1-28.

Aspect 32: A non-transitory computer-readable medium storing code for wireless communication, the code comprising instructions executable by a processor to perform the method of one or more of Aspects 1-28.

Aspect 33: A non-transitory computer-readable medium storing a set of instructions for wireless communication, the set of instructions comprising one or more instructions that, when executed by one or more processors of a device, cause the device to perform the method of one or more of Aspects 1-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a user equipment (UE), comprising:
receiving, for a first wireless communication carrier, a first uplink transmit switching configuration that indicates a first plurality of wireless communication carrier combinations,
wherein the first wireless communication carrier is included in each of the first plurality of wireless communication carrier combinations;
and receiving, for a second wireless communication carrier, a second uplink transmit switching configuration that indicates a second plurality of wireless communication carrier combinations,
wherein the second wireless communication carrier is included in each of the second plurality of wireless communication carrier combinations.

2. The method of claim 1, wherein a wireless communication carrier combination, of the first plurality of wireless communication carrier combinations, includes:
the first wireless communication carrier; and
at least one of:
the second wireless communication carrier, or
a third wireless communication carrier.

3. The method of claim 1, further comprising:
receiving, for a third wireless communication carrier, a third uplink transmit switching configuration that indicates a third plurality of wireless communication carrier combinations,
wherein the third wireless communication carrier is included in each of the third plurality of wireless communication carrier combinations.

4. The method of claim 1, wherein the first uplink transmit switching configuration indicates an uplink transmit period location for a wireless communication carrier combination of the first plurality of wireless communication carrier combinations.

5. The method of claim 1, wherein the UE is configured for uplink transmit switching associated with three or more wireless communication carriers, including the first wireless communication carrier and the second wireless communication carrier.

6. The method of claim 1, further comprising:
receiving a downlink communication that explicitly indicates a wireless communication carrier priority for resolving uplink transmit switching period location conflicts between the first uplink transmit switching configuration and the second uplink transmit switching configuration.

7. The method of claim 6, wherein the downlink communication comprises at least one of:
a radio resource control (RRC) communication,
a medium access control (MAC) control element (MAC-CE) communication, or
a downlink control information (DCI) communication.

8. The method of claim 1, further comprising:
receiving a downlink communication that explicitly indicates a priority order, of wireless communication carriers configured for the UE, for resolving uplink transmit switching period location conflicts between the first uplink transmit switching configuration and the second uplink transmit switching configuration.

9-15. (canceled)

16. A user equipment (UE) for wireless communication, comprising:
a memory; and
one or more processors, coupled to the memory, configured to:
receive, for a first wireless communication carrier, a first uplink transmit switching configuration that indicates a first plurality of wireless communication carrier combinations,
wherein the first wireless communication carrier is included in each of the first plurality of wireless communication carrier combinations; and
receive, for a second wireless communication carrier, a second uplink transmit switching configuration that indicates a second plurality of wireless communication carrier combinations,
wherein the second wireless communication carrier is included in each of the second plurality of wireless communication carrier combinations.

17. The UE of claim 16, wherein a wireless communication carrier combination, of the first plurality of wireless communication carrier combinations, includes:
the first wireless communication carrier; and
at least one of:
the second wireless communication carrier, or
a third wireless communication carrier.

18. The UE of claim 16, wherein the one or more processors are further configured to:
receive, for a third wireless communication carrier, a third uplink transmit switching configuration that indicates a third plurality of wireless communication carrier combinations,
wherein the third wireless communication carrier is included in each of the third plurality of wireless communication carrier combinations.

19. The UE of claim 16, wherein the first uplink transmit switching configuration indicates an uplink transmit period location for a wireless communication carrier combination of the first plurality of wireless communication carrier combinations.

20. The UE of claim 16, wherein the UE is configured for uplink transmit switching associated with three or more wireless communication carriers, including the first wireless communication carrier and the second wireless communication carrier.

21. The UE of claim 16, wherein the one or more processors are further configured to:
receive a downlink communication that explicitly indicates a wireless communication carrier priority for resolving uplink transmit switching period location conflicts between the first uplink transmit switching configuration and the second uplink transmit switching configuration.

22. The UE of claim 21, wherein the downlink communication comprises at least one of:
a radio resource control (RRC) communication,
a medium access control (MAC) control element (MAC-CE) communication, or
a downlink control information (DCI) communication.

23. The UE of claim 16, wherein the one or more processors are further configured to:
receive a downlink communication that explicitly indicates a priority order, of wireless communication carriers configured for the UE, for resolving uplink transmit switching period location conflicts between the first uplink transmit switching configuration and the second uplink transmit switching configuration.

24. A network node for wireless communication, comprising:
a memory; and
one or more processors, coupled to the memory, configured to:
transmit, for a first wireless communication carrier, a first uplink transmit switching configuration that indicates a first plurality of wireless communication carrier combinations,
wherein the first wireless communication carrier is included in each of the first plurality of wireless communication carrier combinations; and
transmit, for a second wireless communication carrier, a second uplink transmit switching configuration that indicates a second plurality of wireless communication carrier combinations,
wherein the second wireless communication carrier is included in each of the second plurality of wireless communication carrier combinations.

25. The network node of claim 24, wherein the one or more processors are further configured to:
transmit a downlink communication that explicitly indicates a priority order, of wireless communication carriers configured for a user equipment (UE), for resolving uplink transmit switching period location conflicts between the first uplink transmit switching configuration and the second uplink transmit switching configuration.

26. The network node of claim 24, wherein the one or more processors are further configured to:
transmit a downlink communication that explicitly indicates respective wireless communication carrier priorities, for each pair combination of wireless communication carriers configured for a user equipment (UE), for resolving uplink transmit switching period location conflicts between each pair combination of wireless communication carriers configured for the UE.

27. The network node of claim 24, wherein the first wireless communication carrier is included in only the first plurality of wireless communication carrier combinations and is not included in any of the second plurality of wireless communication carrier combinations.

28-30. (canceled)
